(19) United States
(12) Patent Application Publication
(10) Pub. No.: US 2024/0334397 A1
(43) Pub. Date: Oct. 3, 2024

(54) ALLOCATING MULTIPLE RESOURCE UNITS OF A MULTI-USER TRANSMISSION TO A SINGLE WIRELESS STATION

(71) Applicant: QUALCOMM Incorporated, San Diego, CA (US)

(72) Inventors: Alfred ASTERJADHI, San Diego, CA (US); George CHERIAN, San Diego, CA (US); Abhishek Pramod PATIL, San Diego, CA (US); Yanjun SUN, San Diego, CA (US); Sai Yiu Duncan HO, San Diego, CA (US); Gaurang NAIK, San Diego, CA (US); Abdel Karim AJAMI, San Diego, CA (US)

(21) Appl. No.: 18/607,025

(22) Filed: Mar. 15, 2024

Related U.S. Application Data
(60) Provisional application No. 63/492,753, filed on Mar. 28, 2023.

(51) Int. Cl. H04W 72/04; H04L 5/00

(52) U.S. Cl. CPC H04W 72/04; H04L 5/0044

(57) ABSTRACT

Various aspects of the present disclosure generally relate to wireless communication. In some aspects, a first wireless communication device may transmit a physical layer protocol data unit (PPDU) that indicates that at least two resource units (RUs) associated with a multiple-user (MU) transmission are allocated to a second wireless communication device. The first wireless communication device may communicate with the second wireless communication device based at least in part on using the at least two RUs associated with the MU transmission. Numerous other aspects are described.

### CROSS-REFERENCE TO RELATED APPLICATION

This Patent application claims priority U.S. Provisional Patent Application No. 63/492,753, filed on Mar. 28, 2023, entitled “ALLOCATING MULTIPLE RESOURCE UNITS OF A MULTI-USER TRANSMISSION TO A SINGLE WIRELESS STATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically, to techniques and apparatuses for allocating multiple resource units of a multiple-user orthogonal frequency division multiple access transmission to a single wireless station.

### BACKGROUND

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network (e.g., a wireless local area network (WLAN), such as a Wi-Fi (i.e., Institute of Electrical and Electronics Engineers (IEEE) 802.11) network) may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink and uplink. “Downlink” may refer to the communication link from the AP to the station, and “uplink” may refer to the communication link from the station to the AP.

In some WLANs, an AP and a STA may support multiple-user (MU) communications, such as multiple-user orthogonal frequency division multiple access (MU-OFDMA) communications and/or MU-MIMO. In some aspects, the MU communications may be concurrent transmissions from one device to each of multiple devices and/or concurrent transmissions from multiple devices to a single device. In MU-OFDMA communications, the concurrent transmissions may be based at least in part on using orthogonal frequency division multiple access, and in MU-MIMO communications, the concurrent transmissions may be based at least in part on spatial diversity of beam transmission. In MU communication schemes, the available frequency spectrum of the wireless channel may be divided into multiple resource units (RUs) based at least in part on multiple frequency subcarriers. Different RUs may be allocated or assigned by an AP to different STAs at particular times.

### SUMMARY

Some aspects described herein relate to a method of wireless communication performed by a first wireless communication device, such as an access point (AP) and/or a wireless station (STA). The method may include transmitting a physical layer protocol data unit (PPDU) that indicates that multiple resource units (RUs) associated with a multiple-user (MU) transmission are allocated to a second wireless communication device, such as another wireless station (STA). The method may include communicating with the second wireless communication device based at least in part on using the at least two RUs associated with the MU transmission.

Some aspects described herein relate to a method of wireless communication performed by a second wireless communication device, such as a wireless station (STA). The method may include receiving a PPDU that indicates at least two RUs associated with an MU transmission are allocated to the second wireless communication device. The method may include communicating with a first wireless communication device, such as another STA and/or an access point (AP) based at least in part on using the at least two RUs associated with the MU transmission.

Some aspects described herein relate to an apparatus for wireless communication at a first wireless communication device, such as an AP and/or an STA. The apparatus may include a memory and one or more processors coupled to the memory. The one or more processors may be configured, individually or collectively, to cause the first wireless communication device to transmit a PPDU that indicates that at least two RUs associated with an MU transmission are allocated to a second wireless communication device, such as another STA. The one or more processors may be configured, individually or collectively, to cause the first wireless communication device to communicate with the second wireless communication device based at least in part on using the at least two RUs associated with the MU transmission.

Some aspects described herein relate to an apparatus for wireless communication at a second wireless communication device, such as an STA. The apparatus may include a memory and one or more processors coupled to the memory. The one or more processors may be configured, individually or collectively, to cause the second wireless communication device to receive a PPDU that indicates at least two RUs associated with an MU transmission are allocated to the second wireless communication device. The one or more processors may be configured, individually or collectively, to cause the second wireless communication device to communicate with a first wireless communication device, such as another STA and/or an AP, based at least in part on using the at least two RUs associated with the MU transmission.

Some aspects described herein relate to a non-transitory computer-readable medium that stores a set of instructions for wireless communication by a first wireless communication device, such as an AP and/or an STA. The set of instructions, when executed by one or more processors of the first wireless communication device, may cause the first wireless communication device to transmit a PPDU that indicates that at least two RUs associated with an MU transmission are allocated to second wireless communication device, such as another STA. The set of instructions, when executed by one or more processors of the first wireless communication device, may cause the first wireless communication device to communicate with the second wireless communication device based at least in part on using the at least two RUs associated with the MU transmission.

Some aspects described herein relate to a non-transitory computer-readable medium that stores a set of instructions for wireless communication by a second wireless communication device, such as an STA. The set of instructions, when executed by one or more processors of the second wireless communication device, may cause the second wireless communication device to receive a PPDU that indicates at least two RUs associated with an MU transmission are allocated to the second wireless communication device. The set of instructions, when executed by one or more processors of the second wireless communication device, may cause the second wireless communication device to communicate with a first wireless communication device, such as another STA and/or an AP) based at least in part on using the at least two RUs associated with the MU transmission.

Some aspects described herein relate to an apparatus for wireless communication. The apparatus may include means for transmitting a PPDU that indicates that at least two RUs associated with an MU transmission are allocated to a second wireless communication device, such as an STA. The apparatus may include means for communicating with the second wireless communication device based at least in part on using the at least two RUs associated with the MU transmission.

Some aspects described herein relate to an apparatus for wireless communication. The apparatus may include means for receiving a PPDU that indicates at least two RUs associated with an MU transmission are allocated to a second wireless communication device, such as an STA. The apparatus may include means for communicating with a first wireless communication device, such as another STA and/or an AP, based at least in part on using the at least two RUs associated with the MU transmission.

Some aspects described herein relate to a method of wireless communication performed by a first wireless communication device. The method may include communicating with a second wireless communication device using a single RU allocation from multiple RUs in a first MU transmission, the single RU allocation being allocated to the second wireless communication device. The method may include transmitting an indication that specifies activation of M-RU MU communications. The method may include communicating with the second wireless communication device using the M-RU MU communications based at least in part on the activation of the M-RU MU communications, the M-RU communications comprising at least one of at least two RUs of a second MU transmission that are allocated to the second wireless communication device.

Some aspects described herein relate to a method of wireless communication performed by a second wireless communication device. The method may include communicating with a first wireless communication device using a single RU allocation from multiple RUs in a first MU transmission, the single RU allocation being allocated to the second wireless communication device. The method may include receiving a first indication that specifies activation of M-RU MU communications. The method may include communicating with the first wireless communication device using the M-RU MU communications based at least in part on the activation of the M-RU MU communications, the M-RU communications comprising at least one of at least two RUs of a second MU transmission that are allocated to the second wireless communication device.

Some aspects described herein relate to an apparatus for wireless communication at a first wireless communication device. The apparatus may include one or more memories and one or more processors coupled to the one or more memories. The one or more processors may be configured to communicate with a second wireless communication device using a single RU allocation from multiple RUs in a first MU transmission, the single RU allocation being allocated to the second wireless communication device. The one or more processors may be configured to transmit an indication that specifies activation of M-RU MU communications. The one or more processors may be configured to communicate with the second wireless communication device using the M-RU MU communications based at least in part on the activation of the M-RU MU communications, the M-RU communications comprising at least one of at least two RUs of a second MU transmission that are allocated to the second wireless communication device.

Some aspects described herein relate to an apparatus for wireless communication at a second wireless communication device. The apparatus may include one or more memories and one or more processors coupled to the one or more memories. The one or more processors may be configured to communicate with a first wireless communication device using a single RU allocation from multiple RUs in a first MU transmission, the single RU allocation being allocated to the second wireless communication device. The one or more processors may be configured to receive a first indication that specifies activation of M-RU MU communications. The one or more processors may be configured to communicate with the first wireless communication device using the M-RU MU communications based at least in part on the activation of the M-RU MU communications, the M-RU communications comprising at least one of at least two RUs of a second MU transmission that are allocated to the second wireless communication device.

Some aspects described herein relate to a non-transitory computer-readable medium that stores a set of instructions for wireless communication by a first wireless communication device. The set of instructions, when executed by one or more processors of the first wireless communication device, may cause the first wireless communication device to communicate with a second wireless communication device using a single RU allocation from multiple RUs in a first MU transmission, the single RU allocation being allocated to the second wireless communication device. The set of instructions, when executed by one or more processors of the first wireless communication device, may cause the first wireless communication device to transmit an indication that specifies activation of M-RU MU communications. The set of instructions, when executed by one or more processors of the first wireless communication device, may cause the first wireless communication device to communicate with the second wireless communication device using the M-RU MU communications based at least in part on the activation of the M-RU MU communications, the M-RU communications comprising at least one of at least two RUs of a second MU transmission that are allocated to the second wireless communication device.

Some aspects described herein relate to a non-transitory computer-readable medium that stores a set of instructions for wireless communication by a second wireless communication device. The set of instructions, when executed by one or more processors of the second wireless communication device, may cause the second wireless communication device to communicate with a first wireless communication device using a single RU allocation from multiple RUs in a first MU transmission, the single RU allocation being allocated to the second wireless communication device. The set of instructions, when executed by one or more processors of the second wireless communication device, may cause the second wireless communication device to receive a first indication that specifies activation of M-RU MU communications. The set of instructions, when executed by one or more processors of the second wireless communication device, may cause the second wireless communication device to communicate with the first wireless communication device using the M-RU MU communications based at least in part on the activation of the M-RU MU communications, the M-RU communications comprising at least one of at least two RUs of a second MU transmission that are allocated to the second wireless communication device.

Some aspects described herein relate to an apparatus for wireless communication. The apparatus may include means for communicating with a second wireless communication device using a single RU allocation from multiple RUs in a first MU transmission, the single RU allocation being allocated to the second wireless communication device. The apparatus may include means for transmitting an indication that specifies activation of M-RU MU communications. The apparatus may include means for communicating with the second wireless communication device using the M-RU MU communications based at least in part on the activation of the M-RU MU communications, the M-RU communications comprising at least one of at least two RUs of a second MU transmission that are allocated to the second wireless communication device.

Some aspects described herein relate to an apparatus for wireless communication by a second wireless communication device. The apparatus may include means for communicating with a first wireless communication device using a single RU allocation from multiple RUs in a first MU transmission, the single RU allocation being allocated to the second wireless communication device. The apparatus may include means for receiving a first indication that specifies activation of M-RU MU communications. The apparatus may include means for communicating with the first wireless communication device based at least in part on using at least one of at least two RUs of a second MU transmission that are allocated to the second wireless communication device.

The systems, methods, and devices of this disclosure each have several innovative aspects, no single one of which is solely responsible for the desirable attributes disclosed herein.

Aspects generally include a method, apparatus, system, computer program product, non-transitory computer-readable medium, user equipment (UE), STA, AP, network node, network entity, wireless communication device, or processing system as substantially described with reference to and as illustrated by the drawings and specification.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 shows a block diagram of an example wireless communication network.

FIG. 2 shows an example protocol data unit (PDU) usable for wireless communication between a wireless access point (AP) and one or more wireless stations (STAs).

FIG. 3 shows an example physical layer PDU (PPDU) that is usable for wireless communication between a wireless AP and one or more wireless STAs.

FIG. 4 is a diagram illustrating an example trigger frame, in accordance with the present disclosure.

FIG. 5 is a diagram illustrating an example of a wireless communication process between an AP and a STA, in accordance with the present disclosure.

FIGS. 6A and 6B are diagrams illustrating a first example and a second example of M-RU communications, in accordance with the present disclosure.

FIG. 7 is a diagram illustrating an example process performed, for example, by an AP, in accordance with the present disclosure.

FIG. 8 is a diagram illustrating an example process performed, for example, by a STA, in accordance with the present disclosure.

FIG. 9 is a diagram illustrating an example process performed, for example, by an AP, in accordance with the present disclosure.

FIG. 10 is a diagram illustrating an example process performed, for example, by a STA, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

FIG. 13 is a diagram illustrating example components of a device, in accordance with the present disclosure.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving radio frequency (RF) signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multiple-user MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

An access point (AP) operating in a WLAN may allocate and/or assign resource units (RUs) to different wireless stations (STAs) based at least in part on multiple-user (MU) transmissions, such as MU-OFDMA transmissions and/or MU-MIMO transmissions, and each resource unit (RU) may be associated with a respective partition of frequency spectrum and a respective partition of time. Some protocol standards may instruct the AP to allocate a single RU (e.g., only one RU) to a STA at a given instance. The RU may be associated with one or more transmission parameters, such as a modulation and coding scheme (MCS) and/or a target power level. Accordingly, for a downlink MU communication that includes the occurrence of the allocated RU, the AP may only transmit a single physical layer service data unit (PSDU) per physical layer protocol data unit (PPDU) to the STA, and the STA may parse a single PSDU per PPDU. Alternatively, or additionally, for uplink MU communications, each STA may be triggered to send a single PSDU per PPDU (e.g., using the allocated RU). Based at least in part on the STA receiving a single RU allocation at a given instance, a PSDU associated with the STA may include multiple medium access control (MAC) protocol data units (MPDUs).

The inclusion of multiple MPDUs in a single PSDU (and, subsequently, a PPDU), may result in the STA failing to meet a performance condition, such as a data-transfer latency condition and/or a data throughput condition. To illustrate, each MPDU of the multiple PDUs in the single PSDU may be associated with a respective data traffic stream, and each data traffic stream may be configured with different performance conditions relative to other data traffic streams. However, the allocation of a single RU may result in each MPDU in the single PSDU having the same transmission parameters and, subsequently, result in the STA failing to meet performance condition(s).

Some techniques and apparatuses described herein provide for allocating at least two resource units of an MU transmission to a single STA. In some aspects, a first wireless communication device, such as an AP and/or an STA, may transmit a (single) PPDU that indicates that at least two RUs associated with an MU transmission (e.g., a downlink MU transmission or an uplink MU transmission) are allocated to a second wireless communication device, such as another STA. Alternatively, or additionally, the first wireless communication device may indicate respective transmission parameters for each RU of the at least two RUs that are allocated to the second wireless communication device. Based at least in part on transmitting the PPDU that indicates that the at least two RUs are allocated to the second wireless communication device, the first wireless communication device may communicate with the second wireless communication device based at least in part on using the at least two RUs associated with the MU transmission.

The ability for a wireless communication device (e.g., an AP and/or an STA) to allocate multiple RUs to a second wireless communication device (e.g., another STA) in a single instance, with varying transmission parameters for each RU, may improve a reliability of communications with the second wireless communication device based at least in part on de-multiplexing transmission parameters associated with each of the data traffic streams. To illustrate, an AP may configure the transmission parameters associated with usage of each RU based at least in part on respective performance conditions as described below. The ability to allocate multiple RUs of an MU transmission to a STA and/or configure each RU with different transmission parameters enables the AP to configure each RU, and subsequently, a transmission that uses the RU, based at least in part on performance condition(s) at the STA. That is, the ability to allocate multiple RUs and configure the transmission parameters of each RU independently may enable the STA to meet the performance conditions, increase a reliability of communications at the STA, and/or increase a robustness of the communications at the STA as described below.

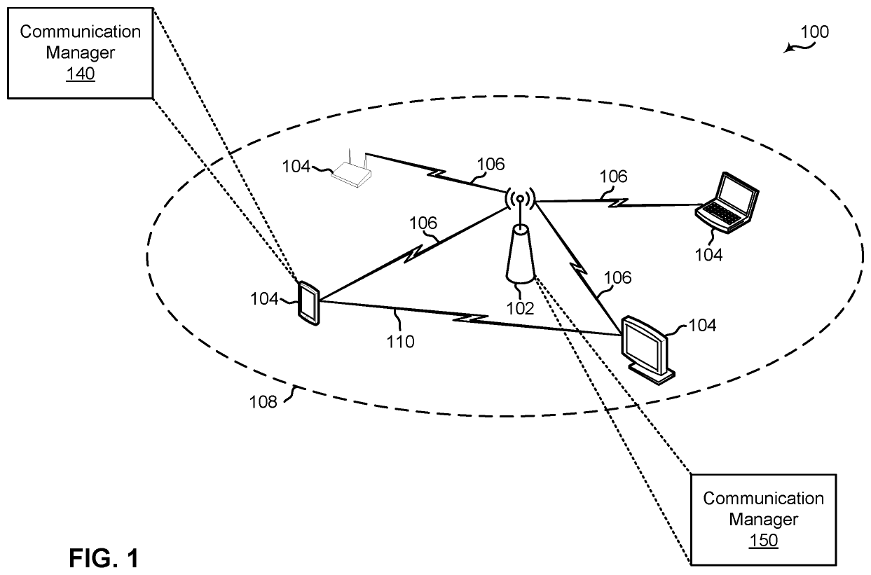

FIG. 1 shows a block diagram of an example wireless communication network 100. According to some aspects, the wireless communication network 100 can be an example of a WLAN such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.1 lay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHZ or 60 GHz bands). To perform passive scanning, a STA 104 listens for beacons, which are transmitted by respective APs 102 at a periodic time interval referred to as the target beacon transmission time (TBTT) (measured in time units (TUs) where one time unit (TU) may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As a result, a STA 104 can be covered by more than one AP 102 and can associate with different APs 102 at different times for different transmissions. Additionally, after association with an AP 102, a STA 104 also May periodically scan its surroundings to find a more suitable AP 102 with which to associate. For example, a STA 104 that is moving relative to its associated AP 102 may perform a “roaming” scan to find another AP 102 having more desirable network characteristics, such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for physical layer (PHY) and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 gigahertz (GHz) band, the 5 GHz band, the 60 GHz band, the 3.6 GHz band, and the 900 megahertz (MHz) band. Some examples of the APs 102 and STAs 104 described herein also may communicate in other frequency bands, such as the 5.9 GHZ and the 6 GHZ bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHz, 5 GHz or 6 GHZ bands, each of which is divided into multiple 20 MHz channels. As a result, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

In some wireless communication environments, extremely high throughput (EHT) systems or other systems compliant with future generations of the IEEE 802.11 family of wireless communication protocol standards may provide additional capabilities over other previous systems (for example, high efficiency (HE) systems or other legacy systems). EHT and newer wireless communication protocols may support flexible operating bandwidth enhancements at APs and STAs, such as broadened operating bandwidths relative to legacy operating bandwidths and/or more granular operation relative to legacy operation. For example, an EHT system may allow communications spanning operating bandwidths of 20 MHz, 40 MHz, 80 MHZ, 160 MHz, 240 MHz and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

APs 102 and STAs 104 can support MU communications. That is, concurrent transmissions from one device to each of multiple devices (for example, multiple simultaneous downlink (DL) communications from an AP 102 to corresponding STAs 104), or concurrent transmissions from multiple devices to a single device (for example, multiple simultaneous uplink (UL) transmissions from corresponding STAs 104 to an AP 102). To support the MU transmissions, the APs 102 and STAs 104 may utilize MU-MIMO and multiple-user orthogonal frequency division multiple access (MU-OFDMA) techniques.

In MU-OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (e.g., some tones may be reserved for other purposes). Similarly, in a 160 MHz channel, up to 74 RUs may be allocated. Larger 52 tone, 106 tone, 242 tone, 484 tone and 996 tone RUs also may be allocated. Adjacent RUs may be separated by a null subcarrier (such as a direct current (DC) subcarrier), for example, to reduce interference between adjacent RUs, to reduce receiver DC offset, and to avoid transmit center frequency leakage.

For UL MU transmissions, an AP 102 can transmit a trigger frame to initiate and synchronize a UL MU-OFDMA transmission and/or a UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective AIDs, and may assign each AID (and thus each STA 104) one or more RUs that can be used to send UL traffic to the AP 102. The AP also may designate one or more random access (RA) RUs that unscheduled STAs 104 may contend for.

In some examples in which a wireless communication device operates in a contiguous 320 MHz bandwidth mode or a 160+160 MHz bandwidth mode. Signals for transmission may be generated by two different transmit chains of the device each having a bandwidth of 160 MHz (and each coupled to a different power amplifier). In some other examples, signals for transmission may be generated by four or more different transmit chains of the device, each having a bandwidth of 80 MHZ.

In some other examples, the wireless communication device may operate in a contiguous 240 MHz bandwidth mode, or a noncontiguous 160+80 MHz bandwidth mode. In some examples, the signals for transmission may be generated by three different transmit chains of the device, each having a bandwidth of 80 MHz. In some other examples, the 240 MHz/160+80 MHz bandwidth modes may also be formed by puncturing 320/160+160 MHz bandwidth modes with one or more 80 MHz subchannels. For example, signals for transmission may be generated by two different transmit chains of the device each having a bandwidth of 160 MHz with one of the transmit chains outputting a signal having an 80 MHz subchannel punctured therein.

The operating bandwidth also may accommodate concurrent operation on other unlicensed frequency bands (such as the 6 GHz band) and a portion of spectrum that includes frequency bands traditionally used by Wi-Fi technology. In noncontiguous examples, the operating bandwidth may span one or more disparate sub-channel sets. For example, the 320 MHz bandwidth may be contiguous and located in the same 6 GHZ band or noncontiguous and located in different bands (such as partly in the 5 GHz band and partly in the 6 GHz band).

In some examples, operability enhancements associated with EHT and newer generations of the IEEE 802.11 family of wireless communication protocols, and in particular operation at an increased bandwidth, may include refinements to carrier sensing and signal reporting mechanisms. Such techniques may include modifications to existing rules, structure, or signaling implemented for legacy systems.

APs and STAs that include multiple antennas may support various diversity schemes. For example, spatial diversity may be used by one or both of a transmitting device or a receiving device to increase the robustness of a transmission. For example, to implement a transmit diversity scheme, a transmitting device may transmit the same data redundantly over two or more antennas.

APs and STAs that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_Tx of transmit antennas exceeds the number N_SS of spatial streams. The N_SS spatial streams may be mapped to a number of space-time streams (N_STS), which are then mapped to N_Tx transmit chains.

APs and STAs that include multiple antennas also may support spatial multiplexing, which may be used to increase the spectral efficiency and the resultant throughput of a transmission. To implement spatial multiplexing, the transmitting device divides the data stream into a number N_SS of separate, independent spatial streams. The spatial streams are then separately encoded and transmitted in parallel via the multiple N_Tx transmit antennas. APs and STAs that include multiple antennas also may support beamforming. Beamforming generally refers to the steering of the energy of a transmission in the direction of a target receiver. Beamforming may be used both in an SU context, for example, to improve a signal-to-noise ratio (SNR), as well as in an MU context, for example, to enable MU-MIMO transmissions (also referred to as SDMA). In the MU-MIMO context, beamforming may additionally or alternatively involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in an MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (for example, in the form of a null data packet (NDP)) to the beamformee. An NDP is a PPDU without any data field. The beamformee may then perform measurements for each of the N_Tx x N_Rx sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may then generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (for example, identify, detect, ascertain, calculate, or compute) how to transmit a signal on each of its antennas to perform beamforming. For example, the steering matrix may be indicative of a phase shift, power level, etc. to use to transmit a respective signal on each of the beamformer's antennas.

A transmitting device may support the use of diversity schemes. When performing beamforming, the transmitting beamforming array gain is logarithmically proportional to the ratio of N_Tx to N_SS. As such, it is generally desirable, within other constraints, to increase the number N_Tx of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP's spatial multiplexing capability, an AP may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For examples, the CSI feedback overhead may be reduced using an implicit channel sounding procedure such as an implicit beamforming report (BFR) technique (such as where STAs transmit NDP sounding packets in the UL while the AP measures the channel) because no BFRs are sent. Once the AP receives the NDPs, it may implicitly assess the channels for each of the STAs and use the channel assessments to configure steering matrices. In order to mitigate hardware mismatches that could break the channel reciprocity on the UL and DL (such as the baseband-to-RF and RF-to-baseband chains not being reciprocal), the AP may implement a calibration method to compensate for the mismatch between the UL and the DL channels. For example, the AP may select a reference antenna, transmit a pilot signal from each of its antennas, and estimate baseband-to-RF gain for each of the non-reference antennas relative to the reference antenna.

In some examples, multiple APs may transmit to one or more STAs at a time utilizing a distributed MU-MIMO scheme. Examples of such distributed MU-MIMO transmissions include coordinated beamforming (CBF) and joint transmission (JT). With CBF, signals (such as data streams) for a given STA may be transmitted by only a single AP. However, the coverage areas of neighboring APs may overlap, and signals transmitted by a given AP may reach the STAs in overlapping basic service sets (OBSSs) associated with neighboring APs as OBSS signals. CBF allows multiple neighboring APs to transmit simultaneously while minimizing or avoiding interference, which may result in more opportunities for spatial reuse. More specifically, using CBF techniques, an AP may beamform signals to in-BSS STAs while forming nulls in the directions of STAs in OBSSs such that any signals received at an overlapping basic service set (OBSS) STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA may be transmitted by multiple coordinated APs. For the multiple APs to concurrently transmit data to a STA, the multiple APs may all need a copy of the data to be transmitted to the STA. Accordingly, the APs may need to exchange the data among each other for transmission to a STA. With JT, the combination of antennas of the multiple APs transmitting to one or more STAs may be considered as one large antenna array (which may be represented as a virtual antenna array) used for beamforming and transmitting signals. In combination with MU-MIMO techniques, the multiple antennas of the multiple APs may be able to transmit data via multiple spatial streams. Accordingly, each STA may receive data via one or more of the multiple spatial streams.

Some wireless communication devices (including both APs and STAs) are capable of multi-link operation (MLO). In some examples, MLO supports establishing multiple different communication links (such as a first link on the 2.4 GHz band, a second link on the 5 GHz band, and the third link on the 6 GHz band) between the STA and the AP. Each communication link may support one or more sets of channels or logical entities. In some cases, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). For example, an AP MLD may include multiple APs each configured to communicate on a respective communication link with a respective one of multiple STAs of a non-AP MLD (also referred to as a “STA MLD”). The STA MLD may communicate with the AP MLD over one or more of the multiple communication links at a given time.

One type of MLO is multi-link aggregation (MLA), where traffic associated with a single STA is simultaneously transmitted across multiple communication links in parallel to maximize the utilization of available resources to achieve higher throughput. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

Aspects of transmissions may vary according to a distance between a transmitter (for example, an AP 102 or a STA 104) and a receiver (for example, another AP 102 or STA 104). Wireless communication devices may generally benefit from having information regarding the location or proximities of the various STAs 104 within the coverage area. In some examples, relevant distances may be determined (for example, calculated or computed) using round trip time (RTT)-based ranging procedures. Additionally, in some examples, APs 102 and STAs 104 may perform ranging operations. Each ranging operation may involve an exchange of fine timing measurement (FTM) frames (such as those defined in the 802.1 laz amendment to the IEEE family of wireless communication protocol standards) to obtain measurements of RTT transmissions between the wireless communication devices.

In some aspects, an AP (e.g., the AP 102) may include a communication manager 150. As described in more detail elsewhere herein, the communication manager 150 may transmit a PPDU that indicates that at least two RUs associated with an MU transmission are allocated to a STA; and communicating with the STA based at least in part on using the at least two RUs associated with the MU transmission. Additionally, or alternatively, the communication manager 150 may perform one or more other operations described herein.

In some aspects, a STA (e.g., the STA 104) may include a communication manager 140. As described in more detail elsewhere herein, the communication manager 140 may receive a PPDU that indicates at least two RUs associated with an MU transmission are allocated to the STA; and communicating with an AP based at least in part on using the at least two RUs associated with the MU transmission. Additionally, or alternatively, the communication manager 140 may perform one or more other operations described herein.

In some aspects, a first wireless communication device (e.g., an AP 102) may include a communication manager 150. As described in more detail elsewhere herein, the communication manager 150 may communicate with a second wireless communication device using a single RU allocation from multiple RUs in a first MU transmission, the single RU allocation being allocated to the second wireless communication device; transmit an indication that specifies activation of multiple RU (M-RU) MU communications; and communicate with the second wireless communication device using the M-RU MU communications based at least in part on the activation of the M-RU MU communications, the M-RU communications comprising at least one of at least two RUs of a second MU transmission that are allocated to the second wireless communication device. Additionally, or alternatively, the communication manager 150 may perform one or more other operations described herein.

In some aspects, a second wireless communication device (e.g., an STA 104) may include a communication manager 140. As described in more detail elsewhere herein, the communication manager 140 may communicate with a first wireless communication device using a single RU allocation from multiple RUs in a first MU transmission, the single RU allocation being allocated to the second wireless communication device; receive a first indication that specifies activation of M-RU MU communications; and communicate with the first wireless communication device using the M-RU MU communications based at least in part on the activation of the M-RU MU communications, the M-RU communications comprising at least one of at least two RUs of a second MU transmission that are allocated to the second wireless communication device. Additionally, or alternatively, the communication manager 140 may perform one or more other operations described herein.

As indicated above, FIG. 1 is provided as an example. Other examples may differ from what is described with regard to FIG. 1.

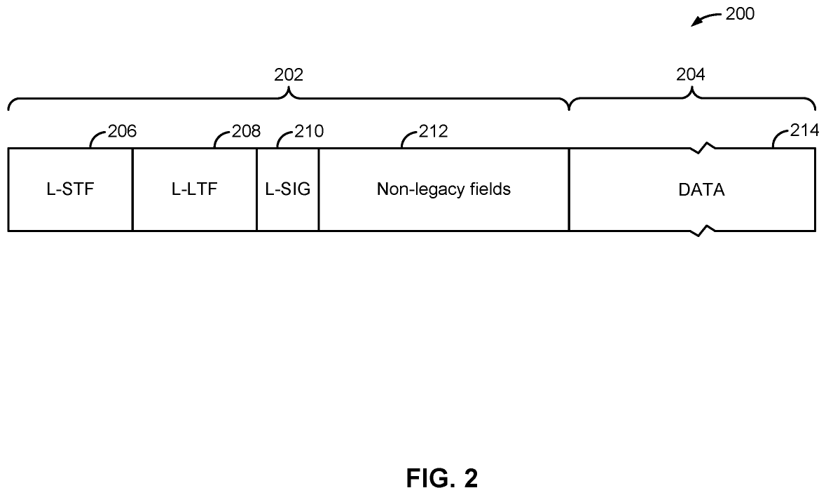

FIG. 2 shows an example protocol data unit (PDU) 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may include two symbols, a legacy long training field (L-LTF) 208, which may include two symbols, and a legacy signal field (L-SIG) 210, which may include two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

As indicated above, FIG. 2 is provided as an example. Other examples may differ from what is described with regard to FIG. 2.

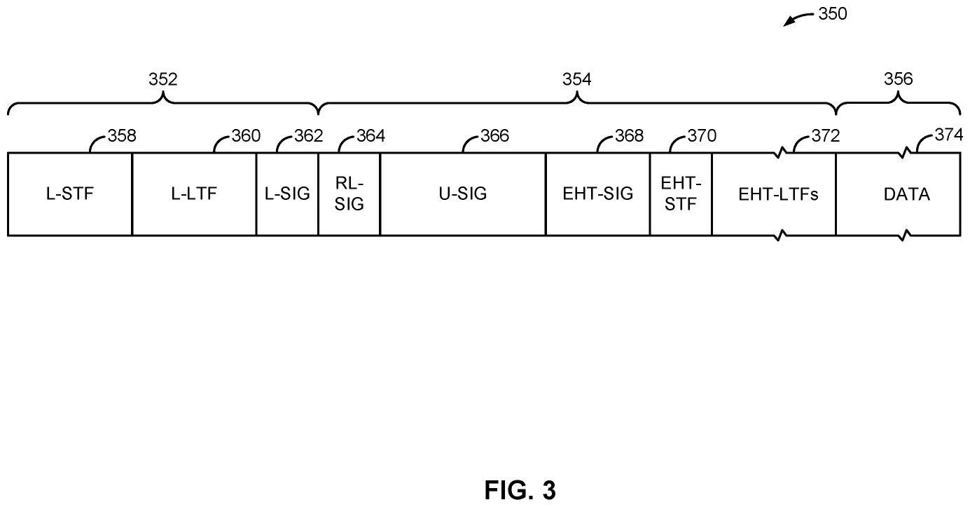

FIG. 3 shows an example PPDU 350 that is usable for wireless communication between a wireless AP (e.g., the AP 102) and one or more wireless STAs (e.g., one or more STA 104). The PPDU 350 may be used for SU, OFDMA, and/or MU-MIMO transmissions. The PPDU 350 may be formatted as an EHT WLAN PPDU in accordance with the IEEE 802.11be amendment to the IEEE 802.11 family of wireless communication protocol standards, or may be formatted as a PPDU conforming to any later (post-EHT) version of a new wireless communication protocol conforming to a future IEEE 802.11 wireless communication protocol standard, such as the 802.11 amendment associated with Wi-Fi 8, or another wireless communication standard. The PPDU 350 includes a PHY preamble including a legacy portion 352 and a non-legacy portion 354. The PPDU 350 may further include a PHY payload 356 after the preamble, for example, in the form of a PSDU including a data field 374.

The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT—or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP to identify and inform one or multiple STAs 104 that the AP has scheduled UL or DL resources for them. EHT-SIG 368 may be decoded by each compatible STA 104 served by the AP 102. EHT-SIG 368 may generally be used by a receiving device to interpret bits in the data field 374. For example, EHT-SIG 368 may include RU allocation information, spatial stream configuration information, and per-user (for example, STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific modulation and coding scheme (MCS) values and user-specific RU allocation information. Such information enables the respective STAs 104 to identify and decode corresponding RUs in the associated data field 374.

As indicated above, FIG. 3 is provided as an example. Other examples may differ from what is described with regard to FIG. 3.

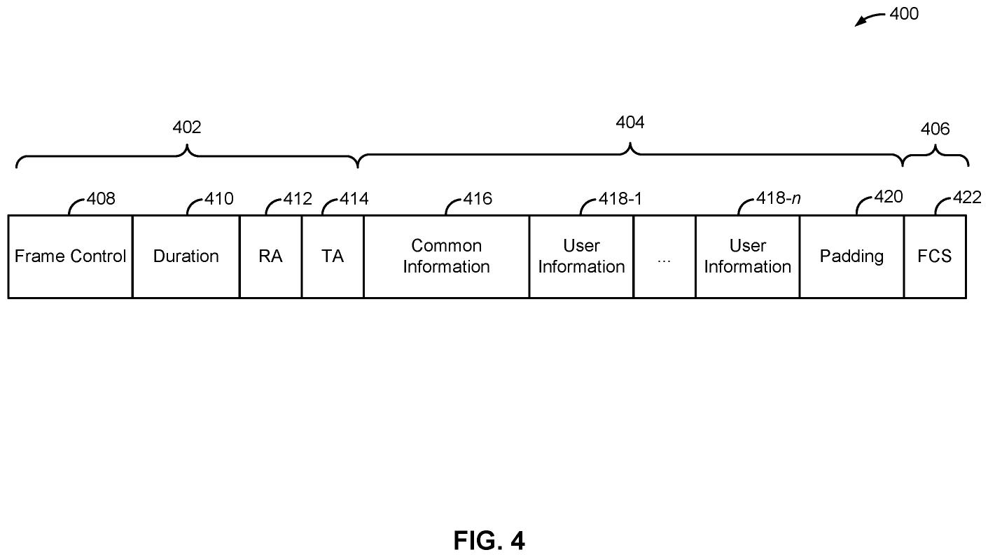

FIG. 4 is a diagram illustrating an example trigger frame 400, in accordance with the present disclosure.

In some aspects, the trigger frame 400 may be a type of MAC control frame that a wireless communication device (e.g., an AP 102 and/or a STA 104) may transmit to request information from another wireless communication device. Alternatively, or additionally, the wireless communication device may transmit the trigger frame 400 to allocate a respective RU to other wireless communication devices for a communication (e.g., a downlink communication or an uplink communication). To illustrate, an AP may transmit the trigger frame 400 to allocate a respective RU of a communication (e.g., a downlink communication or an uplink communication) to each one or more STAs. In MU communications, the wireless communication device may indicate and/or allocate a respective RU to one or more of multiple wireless communication devices using a single trigger frame. As one non-limiting example, an AP may transmit the trigger frame 400 in a DL MU PPDU, and a STA may respond to the trigger frame by transmitting a trigger based (TB) PPDU. For example, the STA may transmit the TB PPDU and generate the PSDU using the RU indicated in the trigger frame.

As shown by FIG. 4, the trigger frame 400 includes a MAC header 402, network data 404 (e.g., a packet/frame body), and a frame/packet end 406. The MAC header 402 includes a frame control field 408, a duration field 410, a receiver address (RA) field 412, and a transmitter address (TA) field 414. However, in alternate or additional examples, a MAC header may include the RA field 412 and/or the TA field 414 with any combination of a basic service set identifier (BSSID) field, a destination address (DA) field, and/or a source address (SA) field. The frame control field 408 may provide information about the frame, such as, by way of example and not of limitation, a frame protocol version, a frame type (e.g., a management frame type, a control frame type, and/or a data frame type), a frame subtype, a distribution system direction (e.g., to a distribution system and/or from a distribution system), retry configuration information, power management information, data protection information, and/or more data information. The duration field 410 may indicate a duration for a timer (e.g., a network allocation vector (NAV) timer) and/or provide contention timing information for wireless access to the network. The RA field 412 may indicate a first MAC address of a receiving STA (and/or group of receiving STAs) and the TA field 414 may indicate a second MAC address of a transmitting STA. That is, the RA field 412 may indicate one or more intended recipients of the network data 404, and the TA field 414 may indicate a signal transmitting STA (e.g., of the network data 404).

The network data 404 includes a common information field 416, n user information fields (shown as user information field 418-1 up to user information field 418-n, where n is an integer), and a padding field 420. The common information field 416 may indicate information that is common to all STAs receiving the trigger frame 400, such as, by way of example and not of limitation, trigger frame type information, an uplink response frame length, an uplink bandwidth, a guard interval length and/or long training field (LTF) type, an MU-MIMO LTF mode, a number of expected high efficiency long training field (HE-LTF) symbols in the response frame, a packet extension duration of the response frame, a Doppler mode, and/or a downlink transmission power. Each user information field (e.g., the user information field 418-1 and the user information field 418-n) may indicate STA-specific information for one or more devices participating in an MU transmission (e.g., a MU-OFDMA transmission and/or a MU-MIMO transmission), such as RU allocation information, AID information, and/or one or more transmit parameters (e.g., a UL MCS and/or a target UL target power level). To illustrate, the user information field 418-1 may indicate a first AID (e.g., assigned to a first STA) and a first RU allocation assigned to the first STA, and the user information field 418-n may indicate an n-th AID (e.g., assigned to an n-th STA) and an n-th RU allocation assigned to the n-th STA. The padding field 420 may be a variable length field that may be used to configure a length of the trigger frame 400.

The packet end 406 may include a frame check sequence (FCS) field 422. In some aspects, the FCS field 422 may include an error-detecting code that a receiving STA may use to detect when the trigger frame 400 includes an error.

As described above, an AP may allocate and/or assign RUs to different STAs based at least in part on OFDMA, and each RU being associated with a respective partition of frequency spectrum (e.g., a subcarrier) and a partition of time. To illustrate, and as described above, the AP may indicate a downlink RU allocation (e.g., specific to the STA) in a preamble of an MU PPDU (e.g., in the EHT-SIG field 368 as described with regard to FIG. 3). Alternatively, or additionally, the AP may indicate an uplink RU allocation (e.g., specific to the STA) in user information (e.g., the user information field 418-1) of a trigger frame. Accordingly, the AP may multiplex data associated with different STAs by transmitting and/or receiving any combination of DL and/or UL communications, respectively. A STA may transmit and/or receive a PSDU to and/or from the AP, respectively, using the allocated RU. As one example, the STA may receive an MU PPDU from the AP using the allocated RU and transmission parameter(s) indicated by the AP to receive and/or decode the MU PPDU. As another example, the STA may transmit a TB PPDU using the allocated RU and transmission parameter(s) indicated by the AP in a trigger frame.

Some protocol standards may specify that the AP may only allocate a single RU to a STA at a given instance, such as a single RU allocation to the STA per DL MU PPDU and/or a single RU allocation to the STA per trigger frame. Accordingly, for a downlink MU transmission that includes the occurrence of the allocated RU, the AP may only transmit a single PSDU per PPDU to the STA, and the STA may parse a single PSDU per PPDU. Alternatively, or additionally, for an uplink MU transmission, each STA may only be triggered to send a single PSDU per PPDU (e.g., using the allocated RU), and the AP may parse multiple PSDUs per PPDU. Based at least in part on the STA receiving a single RU allocation at a given instance, a PSDU associated with the STA may include all MPDUs (e.g., MPDUs that are generated by the STA in an uplink transmission and/or MPDUs received by the STA in a downlink transmission).

The inclusion of multiple MPDUs in a single PSDU (and, subsequently, a PPDU), may result in the STA failing to meet a performance condition (e.g., a priority level condition, a data-transfer latency condition, and/or a data throughput condition). To illustrate, each MPDU of the multiple PDUs in the single PSDU may be associated with a respective data traffic stream, and each data traffic stream may be configured with different performance conditions relative to other data traffic streams. As one example, a first data traffic stream associated with a first MPDU may be associated with a first quality-of-service (QOS) flow, and a second data traffic stream associated with a second MPDU may be associated with a second QoS flow that has one or more different performance conditions relative to the first QoS flow. However, the allocation of a single RU may result in each MPDU in the single PSDU having the same transmission parameters and, subsequently, result in the STA failing to meet performance condition(s).

Some techniques and apparatuses described herein provide for allocating multiple resource units of an MU transmission to a single STA. In some aspects, an AP may transmit a PPDU that indicates that at least two RUs associated with an MU transmission are allocated to a STA. To illustrate, the at least two RUs may be associated with an MU-OFDMA transmission and/or an MU-MIMO transmission. Alternatively, or additionally, the AP may indicate respective transmission parameters for each RU of the at least two RUs that are allocated to the STA. In some aspects, the at least two RUs may be associated with a downlink MU transmission, while in other aspects, the at least two RUs may be associated with an uplink MU transmission. Based at least in part on transmitting the PPDU that indicates the at least two RUs are allocated to the STA, the AP may communicate with the STA based at least in part on using the at least two RUs associated with the MU transmission.

The ability for an AP to allocate multiple RUs to a STA in a single instance, with varying transmission parameters for each RU, may improve a reliability of communications with the STA based at least in part on de-multiplexing transmission parameters associated with each of the data traffic streams. To illustrate, the AP may configure the transmission parameters associated with usage of each RU (e.g., for transmitting and/or receiving a respective MPDU via a respective PSDU and/or a respective PPDU) based at least in part on respective performance conditions. As one example, the AP may configure, in a same MU PPDU and/or a same trigger fame, a first RU allocation with first transmission parameters for a narrowband RU and a second RU allocation with second transmission parameters for a wideband RU. The narrowband RU may be assigned to a first data frame that has a high priority, and the wideband RU may be assigned to a second data frame that has a lower priority relative to the first data frame, thus enabling the STA to meet priority conditions. Alternatively, or additionally, the AP may configure the first RU allocation and the second RU allocation with different guard interval lengths, different MCSs, and/or a different number of spatial streams to enable the STA to meet the performance conditions and improve a reliability of communications at the STA, relative to not meeting the performance conditions.

As another example, and as further described below, the AP may assign multiple RUs (e.g., at least two RUs within a single PPDU) to a STA and indicate a duplication of a PSDU in each transmission associated with a respective RU of the multiple RUs. Accordingly, the STA may transmit and/or receive one or more copies and/or duplications of the same PSDU in respective transmissions associated with each of the RUs. The duplications enable MPDU interleaving over multiple RUs, and improve robustness (e.g., sensitivity to interference and/or signal degradation) of communications by the STA by diversifying transmission of the MPDU and/or mitigating corruption. In some aspects, the duplication of a same PSDU in respective transmissions associated with each of the RUs may improve a transmission range. For example, the AP may configure (e.g., in a same PPDU) multiple narrowband RUs and may indicate that each transmission associated with a respective narrowband RU carries a same PSDU.

Alternatively, or additionally, the ability for an AP to allocate multiple RUs to a STA in a single instance, with varying transmission parameters for each RU, may enable a control channel within a PPDU. To illustrate, the AP may configure at least one RU within a PPDU as a narrowband RU, and transmission(s) associated with the at least one RU may carry one or more broadcast frames. In some aspects, the broadcast frames may be decoded by all STAs, and an M-RU STA may be able to decode both broadcast frames and frames addressed to the M-RU STA in the other RUs of a same and/or single PPDU. Alternatively, or additionally, at least a second RU within the PPDU may be configured as a wideband RU, and transmission(s) associated with the at least second RU may carry one or more data frames. Accordingly, multiple RUs allocated by a PPDU for an MU transmission (e.g., an MU-OFDMA transmission and/or an MU-MIMO transmission) may be configured for simultaneous transmission of control data by a control channel and data frames by a data channel.

As indicated above, FIG. 4 is provided as an example. Other examples may differ from what is described with regard to FIG. 4.

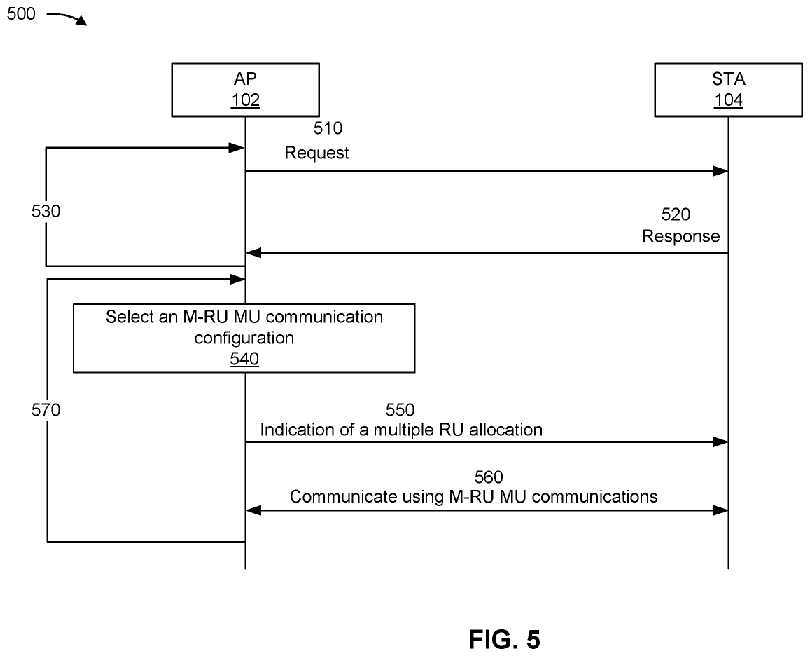

FIG. 5 is a diagram illustrating an example 500 of a wireless communication process between an AP (e.g., the AP 102) and a STA (e.g., the STA 104), in accordance with the present disclosure.

As shown by reference number 510, an AP 102 may transmit, and a STA 104 may receive, one or more requests. In some aspects, and as shown by reference number 520, the STA 104 may transmit, and the AP 102 may receive, a response to the request(s). However, in other examples, the STA 104 may transmit, and the AP 102 may receive, one or more requests (and the AP 102 may transmit a response that may be received by the STA 104). To illustrate, the AP 102 may transmit a request (e.g., either implicitly or explicitly) for multiple-resource unit (M-RU) capability information associated with the STA. For example, the M-RU capability information may indicate whether the STA 104 includes support for duplicate transmissions in an uplink and/or downlink MU transmission (e.g., an MU-OFDMA transmission and/or an MU-MIMO transmission), a maximum number of PSDUs and/or MU PPDUs in a single downlink MU transmission that the STA 104 supports decoding, a maximum number of TB PPDUs in a single uplink MU transmission that the STA 104 supports transmitting, a traffic identifier (TID) set and/or limit, and/or a preferred access class (AC) associated with one or more of the RUs that might be allocated by the AP to the STA in the basic trigger frame. That is, the TID limit and/or the preferred AC may be associated with the basic trigger frame. The TID set may specify for which TIDs the STA intends to use the one or more RUs allocated by the AP. In some aspects, if the TID sets specified for each of the number of RUs overlap, duplication of RUs for the overlapping TIDs may be expected. A TID limit may specify a maximum number of TIDs from which a STA is capable of generating data frames and expected to include in the TB PPDU that is to be sent with the specific allocated RU of the multiple RUs. The preferred AC may indicate the access category queue.

As another example, the AP 102 may indicate (e.g., via a broadcast message) a capability to assign multiple RUs in a (single) PPDU to a STA. Accordingly, the STA 104 may transmit a request to be allocated multiple RUs in the PPDU, and the AP 102 may respond to the request (e.g., implicitly or explicitly).

In some aspects, the AP 102 and/or STA 104 may indicate one or more performance conditions associated with the AP 102 and/or the STA 104, respectively, such as an operating range condition (e.g., an operating distance between the AP 102 and the STA 104), a robustness condition (e.g., sensitivity to interference and/or signal degradation), and/or a reliability condition (e.g., bit errors and/or successful transmission and reception of data). That is, the AP 102 and/or the STA 104 may indicate a target performance and/or a performance indicator for operations with associated with the other device.

Alternatively, or additionally, the AP 102 may indicate a request for device-preferred transmission configuration information (e.g., STA-preferred transmission configuration information) associated with M-RU MU communications (e.g., an MU communication that allocates at least two RUs of an MU transmission to a single STA). To illustrate, and as described above, each RU associated with an M-RU transmission and/or an MU transmission (e.g., an MU-OFDMA transmission and/or an MU-MIMO transmission) may be associated with a respective transmission configuration (e.g., an MCS transmit parameter and/or a target power level transmit parameter). In some aspects, the AP 102 may request one or more device-preferred transmission parameters (e.g., STA-preferred transmission parameters) from the STA 104, and the STA 104 may respond with one or more device-preferred transmission parameters. As one example, the STA 104 may respond with transmission parameter(s) that are based at least in part on an application layer at the STA 104, such as an application layer that requests high robustness and/or an application layer that requests high data throughput. Accordingly, to satisfy a robustness condition, a first device-preferred MCS and/or first STA-preferred MCS may be a first MCS that is a robust MCS (e.g., a lower MCS) relative to other MCSs. To satisfy a data throughput condition, a second device-preferred MCS and/or second STA-preferred MCS may be a second MCS that increases data throughput (e.g., a higher MCS relative to the robust MCS). MCS is provided as an example, and other non-limiting examples of parameters that may impact the performance may include bandwidth of the RUs, guard intervals, use of low density parity check (LDPC), use of binary convolutional code (BCC) encoding, and/or use of a mid-amble. In some aspects, the STA 104 may indicate respective device-preferred transmission parameters and/or STA-preferred transmission parameters for respective RUs and/or the respective MPDUs that are transmitted using the respective RUs. For example, the STA-preferred transmission parameters may be based at least in part on a performance condition associated with an MPDU. Alternatively, or additionally, the STA 104 may indicate respective device-preferred transmission parameters and/or STA-preferred transmission parameters based at least in part on a frame type, such as by indicating a robust MCS for an I-frame that is being transmitted using a first RU, and a less robust MCS for other frames being transmitted using other RUs.

In some aspects, the STA 104 may indicate alternate or additional device preferred MU communication configuration parameters and/or STA-preferred MU communication configuration parameters, such as a number of RUs that is different from a maximum number of RUs supported by the STA and/or whether to enable or disable M-RU MU communications. To illustrate, based at least in part on a battery level failing to satisfy a power threshold, the STA 104 may request, as a STA-preferred MU communication configuration parameter, a fewer number of RUs than a maximum number of RUs that are supported by the STA 104, to reduce processing at the STA 104 and preserve a battery life. As another example, the STA 104 may request, as a STA-preferred MU communication configuration parameter, to disable and/or to enable M-RU MU communications. Accordingly, the AP 102 and the STA 104 (and/or an application layer of the STA 104) may negotiate one or more M-RU MU communication configuration parameters and/or transmission parameter(s) associated with one or more RUs allocated to the STA 104. That is, an application layer of the STA 104 may request and/or control, as the M-RU MU communication configuration parameters and/or transmission parameter(s), a number of RUs allocated to the STA 104, a size of each RU, one or more transmission parameters (e.g., an MCS) assigned to each RU (and, subsequently, a PSDU transmitted based at least in part on the RU), and/or a number of spatial streams (NSS) assigned to each RU. Alternatively, or additionally, the application layer may request and/or control the one or more M-RU MU communication configuration parameters and/or transmission parameter(s) associated with each RU allocated to the STA 104 independently from one another. The negotiation(s) may enable the STA 104 to request, and/or the AP 102 to configure, RUs and, subsequently, respective wireless channels associated with the RUs, with different transmission parameters to satisfy one or more performance conditions.

In some aspects, the AP 102 may indicate to activate M-RU MU communications (e.g., MU-OFDMA communications and/or MU-MIMO communications). Alternatively, or additionally, in other examples, the AP 102 may indicate to deactivate the M-RU MU communications. That is, the AP 102 May dynamically activate and/or deactivate M-RU MU communications. To illustrate, the AP 102 may determine to activate M-RU MU communications with the STA 104 based at least in part on one or more factors, such as the MU capability information (e.g., carried in device capability information and/or STA capability information) indicating that the STA 104 supports M-RU MU communications, a number of available air interface resources satisfying a quantity threshold, and/or in-device coexistence. A STA may dynamically adapt the number of M-RUs (or operating parameters that govern transmission and/or reception for each of these RUs) that the STA is able to transmit/receive at a given time based at least in part on an availability of internal resources (e.g., certain resources may be shared within the device with Bluetooth and/or modem, and may not be available at all times).

The AP 102 may iteratively perform the operations identified by reference number 530. For example, the AP 102 may iteratively transmit one or more requests at 510, and/or the STA 104 may iteratively transmit one or more responses to the requests at 520, examples of which are provided above. Alternatively, or additionally, although the AP 102 initiates a request in the example 500, other examples and/or other iterations may include the STA 104 initiating a request and/or the AP 102 transmitting a response to the request. That is, the AP 102 and/or the STA 104 may iteratively transmit and/or receive a variety of requests and/or responses to obtain information and/or indicate information.

As shown by reference number 540, the AP 102 may select an M-RU MU communication configuration for an uplink and/or downlink MU transmission (e.g., an uplink and/or a downlink M-RU MU transmission in which multiple RUs are allocated to a single STA) between the AP 102 and the STA 104. In some aspects, the AP 102 may select the M-RU MU communication configuration based at least in part on indicating the activation of the M-RU MU communications as described with regard to reference number 510. As one example of selecting an M-RU MU communication configuration, the AP 102 may select a number of RUs of an MU transmission (e.g., an uplink and/or a downlink M-RU MU transmission) to allocate to the STA. In some aspects, the AP 102 may select the number of RUs based at least in part on any combination of device capability information (e.g., STA capability information), M-RU capability information, and/or STA-preferred information. For example, a first number of RUs associated with a downlink MU transmission (e.g., a downlink MU-OFDMA transmission and/or MU-MIMO transmission) may be based at least in part on a maximum number of PSDUs that the STA 104 supports decoding in a single MU transmission. Alternatively, or additionally, a second number of RUs associated with an uplink MU transmission (e.g., an uplink MU-OFDMA transmission and/or MU-MIMO transmission that may be an M-RU MU transmission) may be based at least in part on a maximum number of PSDUs and/or a maximum number of TB PPDUs that the STA 104 supports transmitting. In some aspects, the AP 102 may select the number of RUs to allocate to the STA 104 based at least in part on a TID limit indicated by the STA 104 and/or a preferred AC indicated by the STA 104. In some aspects, the AP 102 may change a number of RUs allocated to the STA 104 and/or one or more transmission parameters associated with the MU communication (e.g., transmission parameter(s) associated with RUs allocated to the STA 104) based at least in part on the activation of M-RU MU communications.

In some aspects, the AP 102 may identify that the STA 104 supports decoding fewer downlink signals (and/or RUs associated with receiving the downlink signals) of a downlink MU transmission than the AP 102 is capable of transmitting. Alternatively, or additionally, the AP 102 may identify that the STA 104 supports transmitting fewer uplink signals (and/or RUs associated with transmitting the uplink signals) of an uplink MU transmission than the AP 102 is capable of decoding. That is, the AP 102 may identify an imbalance between AP M-RU capabilities and STA M-RU capabilities. Subsequently, the AP 102 may select a number of RUs to allocate to the STA 104 based at least in part on a lowest common factor between the devices.

In some aspects, the AP 102 may select, as at least part of the M-RU MU communication configuration, a respective subchannel associated with each RU. That is, the AP 102 may select which RUs of the MU transmission (e.g., an uplink and/or a downlink M-RU MU transmission) to assign to the STA 104 based at least in part on a respective subchannel of each RU. To illustrate, the AP 102 may select RUs with non-adjacent subchannels to spectrally diversify the assigned RUs. However, in other examples, the AP 102 may select RUs with adjacent subchannels. Alternatively, or additionally, the AP 102 may select an RU to assign to the STA 104 based at least in part on a signal quality associated with the RU, such as a signal metric (e.g., RSSI) that is generated based at least in part on the RU and satisfies a quality threshold. In some aspects, the AP 102 may select an RU to assign to the STA 104 based at least in part on an amount of observed traffic (e.g., a traffic load) in the RU. For instance, an amount of observed traffic that satisfies or fails to satisfy a traffic threshold may indicate an availability state (e.g., available or unavailable, respectively) of the RU, and the AP 102 may select RUs that are available and/or refrain from selecting RUs that are unavailable.

The AP 102 may select one or more respective transmission parameters for each allocated RU based at least in part on one or more performance conditions and/or STA-preferred transmission configuration information. For example, the AP 102 may configure first transmission parameter(s) associated with a first RU allocated to the STA 104 with a first MCS and/or a first target transmit power level to satisfy a robustness performance condition. Alternatively, or additionally, the AP 102 may configure second transmission parameter(s) associated with a second RU allocated to the STA 104 with a second MCS and/or a second target transmit power level to satisfy a data throughput performance condition. Accordingly, in some examples, the AP 102 may configure each subchannel and/or each RU with different transmission parameters, but in other examples, the AP 102 may configure each RU allocated to the STA 104 with the same and/or commensurate transmission parameters.

As part of the M-RU MU communication configuration, the AP 102 may enable and/or disable (e.g., disable and/or refrain from enabling) duplicate transmissions in the multiple RUs assigned to the STA 104. The AP 102 may determine to enable and/or disable duplicate transmissions based at least in part on any combination of factors, such as STA-preferred MU communication configuration parameters and/or performance conditions. To illustrate, the AP 102 may enable duplicate transmissions to satisfy a (high) robustness performance condition and/or may disable duplicate transmissions to satisfy a data throughput performance condition. In some aspects, the AP 102 may enable and/or disable duplicate transmissions based at least in part on a signal quality metric, such as by enabling duplicate transmissions based at least in part on the signal quality metric (e.g., RSSI) failing to satisfy a quality threshold and disabling (and/or refraining from enabling) duplicate transmissions based at least in part on the signal quality metric satisfying the quality threshold.

In some aspects, the AP 102 may communicate with a second AP (e.g., another AP 102) that is associated with the STA 104. For example, the STA 104 may maintain multiple connections to multiple APs (e.g., the AP 102 and the second AP) that may be co-located or non-co-located. That is, the STA 104 may be a multi-link device (MLD) that is capable of maintaining multiple links with multiple APs that are co-located and/or non-co-located. In some aspects, the AP 102 may communicate with the second AP using a backhaul link to coordinate RU allocation to the STA 104 (e.g., for a downlink M-RU MU transmission and/or an uplink M-RU MU transmission). That is, the AP 102 and the second AP may communicate with one another to coordinate uplink and/or downlink M-RU allocations for the STA 104 for an uplink and/or downlink M-RU MU transmission. To illustrate, the AP 102 may select one or more RUs associated with an uplink M-RU MU transmission for uplink communications to the second AP. That is, the AP 102 may select a first set of RUs associated with an uplink M-RU MU transmission for first uplink communication(s) between the AP 102 and the STA 104, and a second set of RUs associated with the uplink M-RU MU transmission for second uplink communication(s) between the second AP and the STA 104. However, in other examples, the AP 102 and the second AP may share RU allocation with one another via the backhaul link and/or coordinate RU allocation such that the AP 102 allocates (and indicates to the STA 104) the first set of RUs associated with the uplink M-RU MU transmission, and the second AP 102 allocates (and indicates to the STA 104) the second set of RUs associated with the uplink MU transmission. Accordingly, the AP 102 may indicate RU allocations for multiple APs communicating with the STA 104 and/or may only indicate a portion of RU allocations to the STA 104.

In some aspects, the AP 102 and the second AP may coordinate duplicate transmissions. To illustrate, the AP 102 may receive a request from the second AP to transmit duplicate control information and/or user data to the STA 104. Accordingly, the AP 102 may select one or more RUs for transmitting duplicate information to the STA 104 (e.g., duplicate information as the second AP). By transmitting duplicate information as the second AP, the AP 102 may enable the STA 104 to selectively decode a duplicate transmission that has a higher signal metric (e.g., RSSI and/or SNR) and/or combine decoded data from the duplicate transmissions to improve a robustness and/or reliability of communications. As one example, channel conditions with one of the APs (e.g., the AP 102 or the second AP) may be better (e.g., higher SNR) than the other AP (e.g., the second AP or the AP 102, respectively). Accordingly, transmitting duplicate information (e.g., via duplicate transmissions) based at least in part on using both APs may increase the likelihood of a successful exchange with the STA 104 based at least in part on the better channel conditions of one of the APs and/or the spatial diversity associated with using at least two APs for duplicate transmissions.

As shown by reference number 550, the AP 102 may transmit, and the STA 104 may receive, an indication of an M-RU MU communication configuration. To illustrate, the AP 102 may transmit a PPDU that indicates that multiple RUs associated with an MU transmission (e.g., that is an M-RU MU transmission) are allocated to the STA 104. In some aspects, the AP 102 may transmit the indication that the multiple RUs are allocated to the STA 104 based at least in part on indicating the activation of M-RU MU communications as described above. Alternatively, or additionally, the AP 102 may indicate that multiple RUs are allocated to the STA 104 based at least in part on configuring one or more information fields (e.g., a user information field in a trigger frame and/or a STA information field in a PPDU preamble).

As one example, for RUs associated with an uplink MU transmission (e.g., an M-RU MU transmission), the AP 102 may transmit a trigger frame (e.g., that is carried by the single PPDU), and the trigger frame may indicate that multiple RUs are allocated to the STA for an uplink M-RU MU transmission. For instance, and as described above with regard to FIG. 4, the trigger frame may include multiple user information fields (e.g., the user information field 418-1 and/or the user information field 418-n), and the AP 102 may configure, for each RU allocated to the STA 104, a respective user information field of the multiple user information fields to include a device identifier (e.g., a STA identifier) assigned to the STA (e.g., an AID). That is, each user information field that is associated with a respective RU allocated to the STA 104 may include a same AID, such that two or more of the user information fields are addressed to the same STA 104.

As another example, for RUs associated with a downlink M-RU MU transmission, the AP 102 may indicate that the multiple RUs are allocated to the STA 104 in a signal field of the PPDU (e.g., the EHT-SIG field 368 in the non-legacy portion 354 of the preamble). To illustrate, the signal field may include multiple STA information fields, and the AP 102 may configure each STA information field that is associated with a respective RU allocated to the STA 104 to include a device identifier (e.g., a STA identifier) assigned to the STA (e.g., an AID).

In some aspects, the AP 102 may indicate respective transmission information (e.g., one or more transmit parameters) for each RU allocated to the STA 104. For instance, the AP 102 may include the respective transmission information in the respective information field (e.g., the trigger frame user information field and/or the STA information field in the signal field of the PPDU preamble) associated with the respective RU. Alternatively, or additionally, the AP 102 may indicate that the MU transmission (e.g., an uplink and/or a downlink M-RU MU transmission) is expected to include duplicate transmissions (e.g., transmissions that are based at least in part on the RUS allocated to the STA 104). To illustrate, the AP 102 may duplicate all information (e.g., except for RU configuration information) in each information field that is addressed to the STA to indicate that an M-RU MU transmission (e.g., a downlink M-RU MU transmission and/or an uplink M-RU MU transmission) expected to include a duplicate transmission. Accordingly, all information fields associated with the STA 104 may include duplicate information, or only a portion of the information fields associated with the STA 104 may include duplicate information.

As shown by reference number 560, the AP 102 and the STA 104 may communicate with one another based at least in part on the M-RU MU communication configuration. In some aspects, the AP 102 and the STA 104 may communicate with one another based at least in part on using the multiple RUs associated with the MU transmission (e.g., an M-RU MU transmission). Communicating with one another may include processing the MU transmission (e.g., a TB PPDU and/or a DL PPDU), and/or each respective signal of the MU transmission that is associated with the STA 104, based at least in part on respective transmission information associated with a respective RU used to transmit the respective signal. That is, the AP 102 and/or the STA 104 may transmit each respective signal of the MU transmission based at least in part on the respective transmission information and/or receiving each respective signal based at least in part on the respective transmission information and/or the RUs allocated to the STA 104.

As one example, the AP 102 may transmit (and the STA 104 may receive) onc or more downlink MU PPDUs that are directed to the STA 104 based at least in part on the multiple RUs allocated to the STA 104. That is, the AP 102 may transmit a respective downlink signal of a downlink MU transmission based at least in part on using a respective RU allocated to the STA 104, and each respective downlink signal may carry a respective downlink MU PPDU that includes a one or more PSDUs that is directed to the STA 104. Each PSDU may include one or more MPDUs addressed to the STA 104 and/or a null data packet addressed to the STA 104. Alternatively, or additionally, the AP 102 may transmit each respective downlink signal based at least in part on the respective transmission information as described above. In some aspects, at least some of the respective PSDUs carried by the respective downlink signals may be duplicates of one another. That is, the AP 102 may transmit duplicate PSDUs in respective downlink signals using the multiple RUs of the downlink MU transmission that are allocated to the STA 104. By transmitting duplicate information, the AP 102 may enable the STA 104 to selectively decode a duplicate transmission that has a higher signal metric (e.g., RSSI) and/or combine decoded data from the duplicate transmissions to improve a robustness and/or reliability of communications.

As another example, the STA 104 may transmit (and the AP 102 may receive) one or more TB PPDUs based at least in part on the multiple RUs that are allocated to the STA 104. That is, the STA 104 may transmit a respective uplink signal of an uplink MU transmission based at least in part on using a respective RU, and each respective uplink signal may carry a respective TB PPDU directed to the AP 102. Alternatively, or additionally, the STA 104 may transmit each respective uplink signal based at least in part on the respective transmission information as described above. In some aspects, each TB PPDU may carry a respective PSDU, while in other aspects at least some of the TB PPDU may include duplicate payloads (e.g., duplicate PSDUs). Alternatively, or additionally, the STA 104 may transmit one or more MPDUs (e.g., in respective TB PPDUs). In some aspects, the MPDU(s) may be based at least in part on a TID limit and/or TID set and/or a preferred AC that is specified in each User Info field that carries the specific RU and is addressed to the STA. TID Limit and preferred AC may help the AP to direct, require, and/or recommend that the STA to only send data frames from a given TID set and/or help the AP specify a TID limit that belongs to the preferred AC or to an AC that has a higher priority than the preferred AC.

In some aspects, the STA 104 may utilize fewer RUs than allocated by the AP 102. To illustrate, the AP 102 may select and/or allocate M RUs to the STA 104 as described with regard to reference number 540 and reference number 550, and the STA 104 may transmit using N RUs of the uplink MU transmission (e.g., for NTB PPDUs), where M is a first integer and N is a second integer, and N may be less than or equal to M. For example, the STA 104 may select (and use) a first allocated RU for transmitting a first TB PPDU based at least in part on a signal quality associated with the RU (e.g., an RSSI satisfies a quality threshold). Alternatively, or additionally, the STA 104 may refrain from using a second allocated RU for transmitting a second TB PPDU based at least in part on the signal quality associated with the second allocated RU failing to satisfy the quality threshold. In some aspects, the STA 104 may select an RU that increases a likelihood of reception, such as an RU with less observed interference, an RU with a lower amount of observed traffic, and/or an RU associated with a higher SNR. To illustrate, the STA 104 may select an RU based at least in part on a quality of the RU that may be indicated by any combination of an amount of observed traffic (e.g., a traffic load) in the RU, an availability state (e.g., available or unavailable, respectively) associated with the RU, and/or a signal metric associated with the RU as described above. Accordingly, for uplink transmissions, the STA 104 may utilize fewer RUs than allocated to the STA 104.

The AP 102 and the STA 104 may iteratively perform MU communications (e.g., MU-OFDMA communications and/or MU-MIMO communications that may or may not be M-RU MU communications) and/or iteratively reconfigure the MU communications, as shown by reference number 570. That is, the AP 102 and the STA 104 may iteratively perform MU communications by reusing the same M-RU MU communication configuration parameters and/or by using updated M-RU MU communication configuration parameters. In some aspects, after completion of the MU communications, the AP 102 may transmit, and the STA 104 may receive, an indication to deactivate M-RU MU communications. Alternatively, or additionally, the AP 102 may dynamically switch from communicating with the STA 104 using M-RU MU to using MLO communications. That is, the AP 102 may enable MLO communication with the STA based at least in part on deactivating M-RU MU communications. Accordingly, the AP 102 may iteratively activate and/or deactivate M-RU MU communications. The AP 102 may alternatively, or additionally change a number of RUs allocated to the STA 104 and/or one or more transmission parameters associated with the MU communication (e.g., transmission parameter(s) associated with RUs allocated to the STA 104) based at least in part on the activation and/or deactivation of M-RU MU communications.

The ability for an AP to allocate multiple RUs to a STA in a single instance, with varying transmission parameters for each RU, may enable the AP to configure transmissions with different transmission properties (e.g., MCS, guard interval, and/or a transmit power level). The ability to configure transmissions with different properties may enable the STA to request and/or the AP to configure the transmissions based at least in part on performance conditions associated with data traffic carried by the transmissions and enable the STA to meet performance conditions. Alternatively, or additionally, the ability to configure transmissions with different properties may enable the AP and/or STA to increase a reliability and/or robustness of communications between the AP and/or STA.

As indicated above, FIG. 5 is provided as an example. Other examples may differ from what is described with regard to FIG. 5.

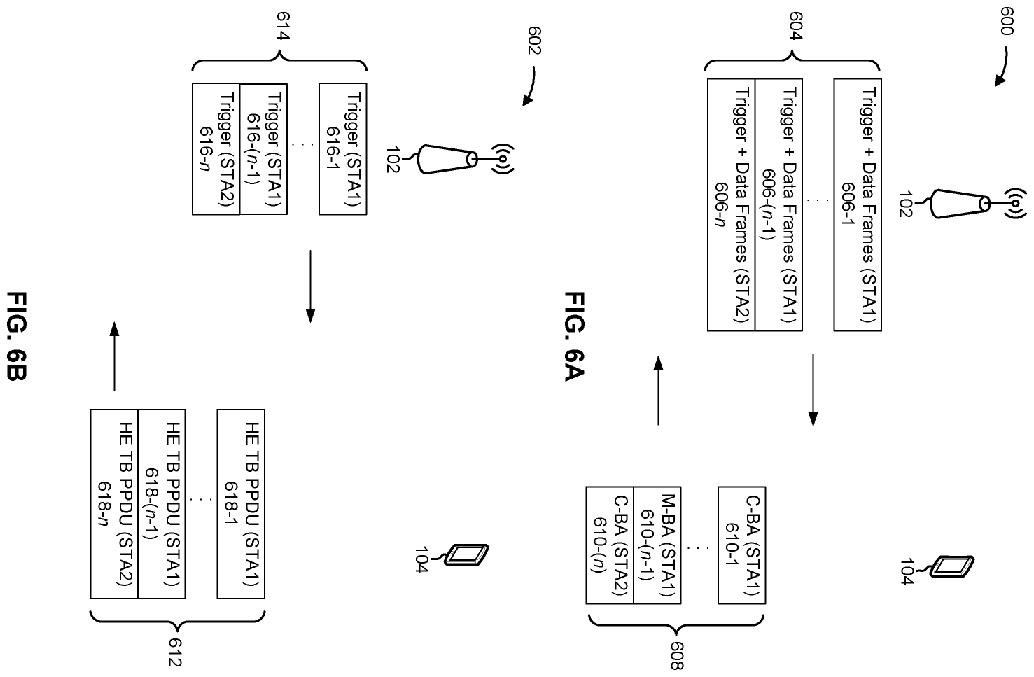

FIGS. 6A and 6B are diagrams illustrating a first example 600 and a second example 602 of M-RU communications, in accordance with the present disclosure.

The first example 600 shown by FIG. 6A includes a downlink MU PPDU transmission 604 that is transmitted by an AP 102, where the downlink MU PPDU 604 is based at least in part on n RUs and n is an integer. In some aspects, the downlink MU PPDU 604 may be an MU transmission that is based at least in part on MU-OFDMA and/or MU-MIMO. Accordingly, a horizontal axis of the downlink MU PPDU 604 represents time, and a vertical axis of the downlink MU PPDU 604 may represent any combination of frequency and/or signal diversity (e.g., spatial diversity and/or polarization diversity). That is, the vertical axis may represent sub-carrier bands, beams with different spatial diversity, and/or beams with polarization diversity. To illustrate, the downlink MU PPDU 604 may be partitioned into n RUs, where n is an integer. Each partition may be characterized based at least in part on a time partition (e.g., a time duration) and/or a frequency partition (e.g., a respective frequency span and/or a respective sub-carrier). In some aspects, each partition may additionally be characterized based at least in part on a respective signal diversity. Accordingly, the MU PPDU 604 may be based at least in part on n signal transmissions, and each signal transmission may be based at least in part on a respective RU. Each signal transmission may carry different information (and/or duplicate information as described above), and some of the n signal transmissions may be directed to a (same) STA 104. That is, multiple RUs associated with the downlink MU PPDU 604 and, subsequently, the signal transmissions associated with the multiple RUs, may be assigned to the STA 104. For example, and as described above, one or more STA information fields of a preamble (not shown in FIG. 6A) associated with the MU PPDU 604 may be set to a same AID associated with the STA 104.

In some aspects, the MU PPDU 604 shown by FIG. 6A includes information that is carried in the data field 374 as described with regard to FIG. 3, and each signal transmission of the n signal transmissions may carry respective information (and/or duplicate information) based at least in part on the respective signal diversity. Alternatively, or additionally, each signal transmission may be based at least in part on respective transmission parameters. In the example 600, n-1 RUs of the downlink MU PPDU 604 are assigned to the STA 104. Accordingly, a first signal transmission of the MU PPDU 604 may carry first information 606-1, such as an MPDU that includes trigger information and data frames, that is directed and/or assigned to the STA 104 (shown as STA1). Alternatively, or additionally, an (n−1)-th signal transmission of the MU PPDU 604 may carry (n−1)-th information 606-(n−1) (e.g., an (n−1)-th MPDU that includes trigger information and data frames) that is directed and/or assigned to the STA 104. The first information 606-1 and the (n−1)-th information 606-(n−1) may be distinct information or duplicate information. At least one RU of the MU PPDU 604 may be assigned to a second, different STA (not shown in FIG. 6A or 6B) based at least in part on the MU PPDU 604 being associated with an MU transmission. To illustrate, an n-th signal transmission of the MU PPDU 604 may carry n-th information 606-(n) (e.g., an n-th MPDU that includes trigger information and data frames) that is directed and/or assigned to the second STA (shown as STA2).

In some aspects, the STA 104 may respond to the downlink MU PPDU 604 by transmitting one or more TB PPDUs as shown by reference number 608. In some aspects, the STA 104 may transmit a respective TB PPDU for each MPDU received based at least in part on the MU PPDU 604. To illustrate, the STA 104 may transmit a first TB PPDU 610-1 that carries a compressed block acknowledgement (C-BA) and/or an (n−1)-th TB PPDU 610-(n−1) that carries a multi-STA block acknowledgement (M-BA). Alternatively, or additionally, a second, different STA may transmit an n-th TB PPDU 610-n that carries a C-BA (e.g., from the second STA).

The second example 602 shown by FIG. 6B includes an uplink MU transmission 612 that is transmitted, at least in part, by the STA 104. As shown by FIG. 6B, the uplink MU transmission 612 may be based at least in part on n RUs, and may be an MU transmission that is based at least in part on MU-OFDMA and/or MU-MIMO. Similar to the downlink MU PPDU 604, a horizontal axis of the uplink MU transmission 612 represents time, and a vertical axis of the uplink MU transmission 612 may represent any combination of frequency and/or signal diversity.

In some aspects, the AP 102 may allocate two or more RUs of the n RUs to the STA 104. For example, and as shown by reference number 614, the AP 102 may set one or more user information fields of a trigger frame to a same AID associated with the STA 104, such as by setting a first user information field 616-1 of the trigger frame to an AID of the STA 104 and an (n−1)-th user information field 616-(n−1) to the AID of the STA 104. Alternatively, or additionally, the AP 102 may set an n-th user information field 616-n to a second AID associated with a second, different STA (not shown in FIG. 6B).

Based at least in part on receiving the allocation of the two or more (uplink) RUs, the STA 104 may generate and transmit multiple uplink signal transmissions that are at least part of the uplink MU transmission 612. The STA 104 may transmit a first uplink signal transmission that carries a first TB PPDU 618-1 (shown as an HE TB PPDU) and an (n−1)-th uplink signal transmission that carries a (n−1)-th TB PPDU 618-(n−1). Each uplink signal transmission may carry different information and/or duplicate information as described above. Alternatively, or additionally, each uplink signal transmission may be based at least in part on different transmit parameters. In the example 602, a n-th signal transmission of the uplink MU transmission 612 may be generated and transmitted by a second, different STA, and may carry an n-th TB PPDU 618-n.

While the example 602 does not include block acknowledgements (BAs), other examples may include the STA 104 transmitting one or more BAs in a manner as illustrated in and described with regard to FIG. 6A. For example, the STA 104 may transmit one or more C-BAs and/or one or more M-BAs to the AP 102.

As indicated above, FIGS. 6A and 6B are provided as examples. Other examples may differ from what is described with regard to FIGS. 6A and 6B.

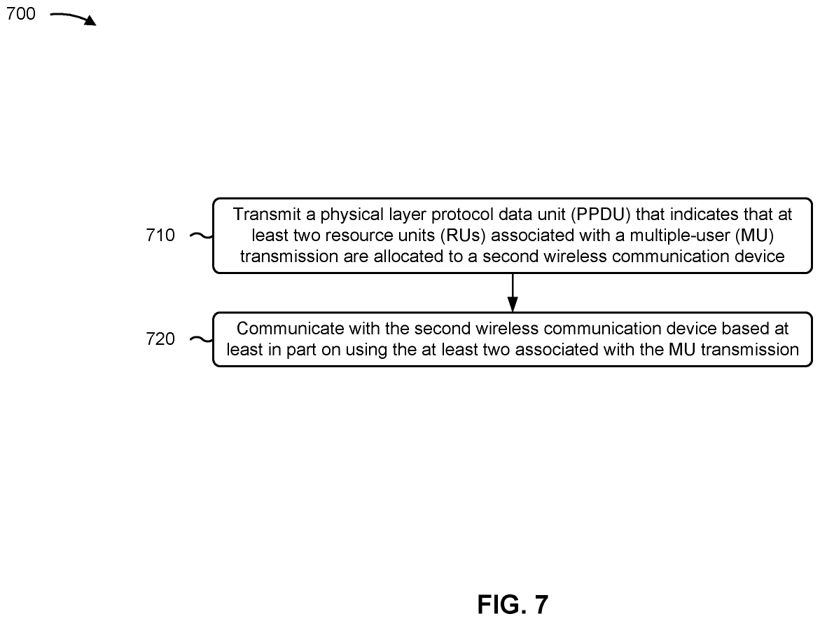

FIG. 7 is a diagram illustrating an example process 700 performed, for example, by first wireless communication device, such as an AP (e.g., an AP 102), in accordance with the present disclosure. Example process 700 is an example where the first wireless communication device performs operations associated with allocating multiple resource unites of an MU transmission to a second wireless communication device (e.g., a single STA 104).

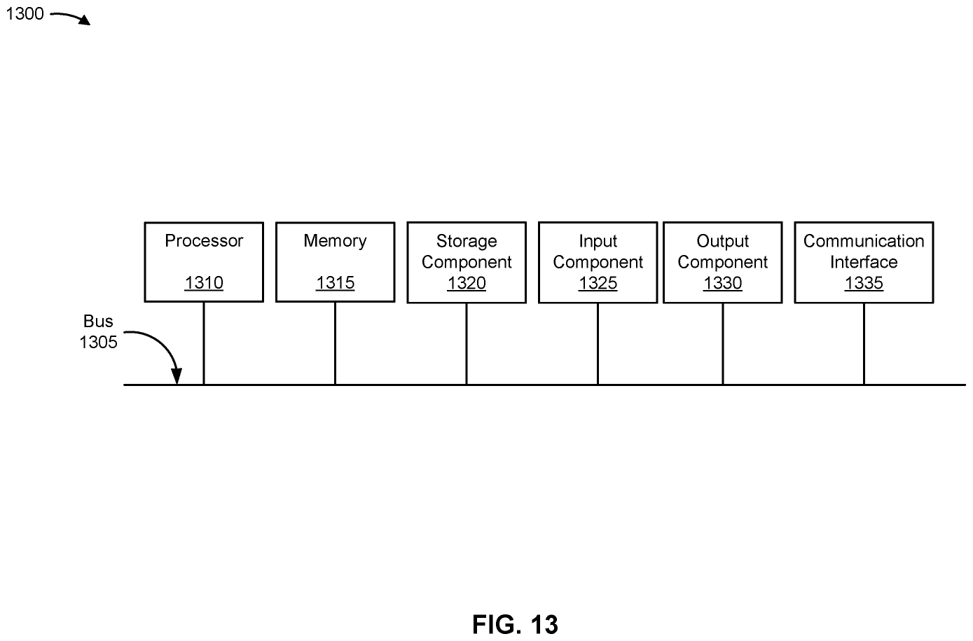

As shown in FIG. 7, in some aspects, process 700 may include transmitting a PPDU that indicates that at least two RUs associated with an MU transmission are allocated to a second wireless communication device (e.g., an STA 104) (block 710). For example, the first wireless communication device (e.g., using communication interface 1335, depicted in FIG. 13, and/or communication manager 150, depicted in FIG. 1) may transmit a PPDU that indicates that at least two RUs associated with an MU transmission are allocated to a second wireless communication device, as described above, e.g., in connection with reference number 550.

As further shown in FIG. 7, in some aspects, process 700 may include communicating with the second wireless communication device based at least in part on using the at least two RUs associated with the MU transmission (block 720). For example, the first wireless communication device (e.g., using communication interface 1335, depicted in FIG. 13, and/or communication manager 150, depicted in FIG. 1) may communicate with the second wireless communication device based at least in part on using the at least two RUs associated with the MU transmission, as described above (e.g., in connection with reference number 560 of FIG. 5).

Process 700 may include additional aspects, such as any single aspect or any combination of aspects described below and/or in connection with one or more other processes described elsewhere herein.

In a first aspect, the MU transmission includes at least one of an MU-OFDMA transmission, or an MU-MIMO transmission (e.g., as described in connection with FIG. 5).

In a second aspect, the at least two RUs are associated with an uplink MU transmission, and process 700 includes transmitting, in a trigger frame, an indication that the at least two RUs are allocated to the second wireless communication device (e.g., as described in connection with FIG. 5).

In a third aspects, communicating with the STA based at least in part on using the at least two RUs includes receiving one or more MPDUs (e.g., as described in connection with FIG. 5).

In a fourth aspects, the trigger frame includes at least one user information field that indicates at least one of: a TID limit associated with a basic trigger frame, or a preferred AC associated with the basic trigger frame, and receiving the one or more MPDUs is based at least in part on the at least one of the TID limit or the preferred AC (e.g., as described in connection with FIG. 5).

In a fifth aspect, communicating with the second wireless communication device based at least in part on using the at least two RUs includes receiving one or more MPDUs based at least in part on the at least one of the TID limit or the preferred AC (e.g., as described in connection with FIG. 5).

In a sixth aspect, the at least two RUs are associated with a downlink MU transmission, and process 700 includes transmitting, in a signal field of the PPDU, an indication that the at least two RUs are allocated to the second wireless communication device (e.g., as described in connection with FIG. 5).

In a seventh aspect, the signal field includes a respective STA information field for each RU of the at least two RUs, and the indication includes each respective STA information field including a device identifier (e.g., a STA identifier) assigned to the second wireless communication device (e.g., as described in connection with FIG. 5).

In an eighth aspect, process 700 includes indicating respective transmission information for each RU of the at least two RUs allocated to the second wireless communication device (e.g., as described in connection with FIG. 5).

In a ninth aspect, process 700 includes duplicating, in at least two information fields carried by the PPDU, all content of each information field of the at least two information fields except RU configuration information, each information field of the at least two information fields being addressed to the second wireless communication device and associated with a respective RU of the at least two RUs (e.g., as described in connection with FIG. 5).

In a tenth aspect, each respective information field of the at least two information fields, is at least one of a trigger frame user information field, or a STA information field of a signal field that is included in the PPDU (e.g., as described in connection with FIG. 5).

In an eleventh aspect, duplicated content in the at least two information fields is an indication that the MU transmission is expected to carry duplicate transmissions (e.g., as described in connection with FIG. 5).

In a twelfth aspect, communicating with the second wireless communication device based at least in part on using the at least two RUs includes receiving, using the MU transmission, duplicate PSDUs based at least in part on using the at least two RUs (e.g., as described in connection with FIG. 5).

In a thirteenth aspect, communicating with the second wireless communication device based at least in part on using the at least two RUs includes transmitting, as at least part of the MU transmission, duplicate PSDUs based at least in part on using the at least two RUs (e.g., as described in connection with FIG. 5).

In a fourteenth aspect, each RU of the at least two RUs is configured with a respective subchannel associated with the MU transmission (e.g., as described in connection with FIG. 5).

In a fifteenth aspect, communicating with the second wireless communication device based at least in part on using the at least two RUs includes receiving, using the MU transmission, at least one TB PPDU based at least in part on the at least two RUs (e.g., as described in connection with FIG. 5).

In a sixteenth aspect, the at least two RUs include M RUs, the at least one TB PPDU includes NTB PPDUs, M is a first integer, N is a second integer, and N is less than or equal to M (e.g., as described in connection with FIG. 5).

In a seventeenth aspect, each TB PPDU of the at least one TB PPDU is associated with a respective PSDU (e.g., as described in connection with FIG. 5). In an eighteenth aspect, communicating with the second wireless communication device based at least in part on using the at least two RUs includes transmitting, using the MU transmission, an MU PPDU based at least in part on the at least two RUs, the MU PPDU includes one or more physical layer service data units (PSDU), and each PSDU of the one or more PSDU includes at least one of: one or more MPDUs addressed to the second wireless communication device, or a null data packet addressed to the second wireless communication device (e.g., as described in connection with FIG. 5).

In a nineteenth aspect, process 700 includes selecting an RU of the at least two RUs for transmitting the MU PPDU based at least in part on at least one of a signal quality associated with the RU, or an availability state associated with the RU (e.g., as described in connection with FIG. 5).

In a twentieth aspect, process 700 includes selecting a number of RUs associated with the MU transmission to allocate to the second wireless communication device based at least in part on device capability information (e.g., STA capability information as described in connection with FIG. 5).

In a twenty-first aspect, communicating with the second wireless communication device based at least in part on using the at least two RUs associated with the MU transmission includes processing a respective signal, of the MU transmission, for each RU of the at least two RUs based at least in part on respective transmission information associated with the RU (e.g., as described in connection with FIG. 5).

In a twenty-second aspect, processing the respective signal that is associated with each RU includes at least one of transmitting the respective signal for each RU as part of the MU transmission based at least in part on the respective transmission information, or receiving the respective signal for each RU as at least part of the MU transmission based at least in part on the respective transmission information (e.g., as described in connection with FIG. 5).

In a twenty-third aspect, the MU transmission includes an uplink TB PPDU (e.g., as described in connection with FIG. 5).

In a twenty-fourth aspect, the MU transmission includes a downlink MU PPDU (e.g., as described in connection with FIG. 5).

In a twenty-fifth aspect, process 700 includes communicating with the second wireless communication device to obtain M-RU capability information associated with the second wireless communication device, and selecting a number of RUs associated with the MU transmission to allocate to the second wireless communication device based at least in part on the M-RU capability information (e.g., as described in connection with FIG. 5).

In a twenty-sixth aspect, the M-RU capability information indicates device capabilities (e.g., STA capabilities) associated with at least one of duplicating transmission support, a maximum number of decodable PSDUs, or a performance condition (e.g., as described in connection with FIG. 5).

In a twenty-seventh aspect, process 700 includes communicating with the second wireless communication device to obtain device-preferred transmission configuration information (e.g., STA-preferred transmission configuration information) associated with M-RU MU communications, and selecting respective transmission information associated with each RU of the at least two RUs based at least in part on the device-preferred transmission configuration information (e.g., as described in connection with FIG. 5).

In a twenty-eighth aspect, the device-preferred transmission configuration information is based at least in part on an application layer at the second wireless communication device (e.g., as described in connection with FIG. 5).

In a twenty-ninth aspect, process 700 includes indicating, to the second wireless communication device, activation of M-RU MU communications, and transmitting the PPDU that indicates the at least two RUs are allocated to the second wireless communication device is based at least in part on activation of the M-RU MU communications (e.g., as described in connection with FIG. 5).

In a thirtieth aspects, process 700 includes changing, based at least in part on the activation, at least one of: a number of RUs allocated to the second wireless communication device, or one or more transmission parameters associated with the MU communication (e.g., as described in connection with FIG. 5).

In a thirty-first aspect, process 700 includes indicating, to the second wireless communication device, deactivation of the M-RU MU communications (e.g., as described in connection with FIG. 5).

In a thirty-second aspect, process 700 includes enabling multi-link operations with the second wireless communication device based at least in part on the deactivation of the M-RU MU communications (e.g., as described in connection with FIG. 5).

In a thirty-third aspect, process 700 includes changing, based at least in part on the deactivation, at least one of: a number of RUs allocated to the second wireless communicaiton device, or one or more transmission parameters associated with the MU communication (e.g., as described in connection with FIG. 5).

In a thirty-fourth aspect, the first wireless communication device is a first AP, and process 700 includes communicating with a second AP that is in communication with the second wireless communication device, selecting at least one RU of the at least two RUs for second wireless device communications (e.g., STA communications) with the second AP, and indicating a configuration of the at least one RU to the second AP (e.g., as described in connection with FIG. 5).

In a thirty-fifth aspect, the first wireless communication device is an AP (e.g., an AP 102), and the second wireless communication device is an STA (e.g., an STA 104) (e.g., as described in connection with FIG. 5).

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

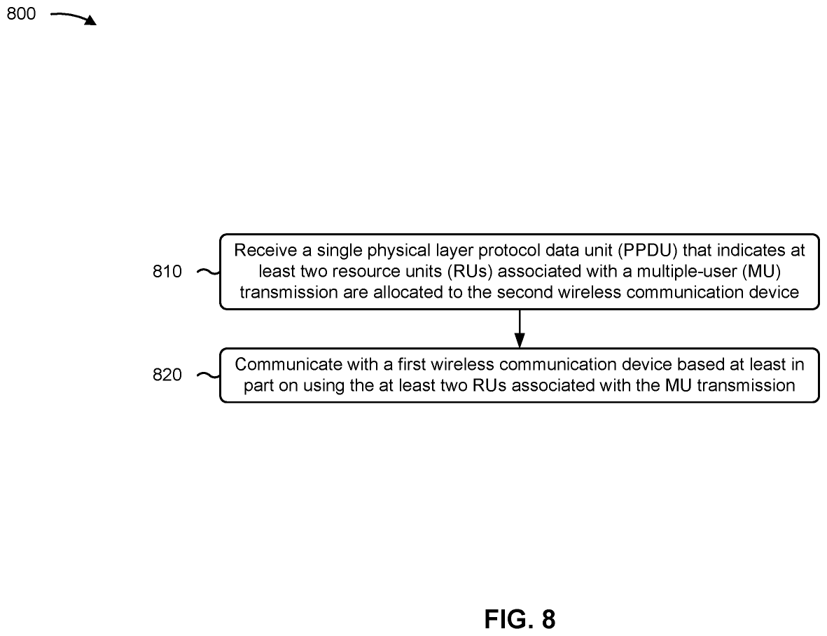

FIG. 8 is a diagram illustrating an example process 800 performed, for example, by a second wireless communication device (e.g., an STA 104), in accordance with the present disclosure. Example process 800 is an example where the second wireless communication device performs operations associated with being allocated multiple RUs of an MU transmission.

As shown in FIG. 8, in some aspects, process 800 may include receiving a single physical layer protocol data unit (PPDU) that indicates at least two RUs associated with an MU transmission are allocated to the second wireless communication device (block 810). For example, the second wireless communication device (e.g., using communication interface 1335, depicted in FIG. 13 and/or communication manager 140, depicted in FIG. 1) may receive a PPDU that indicates at least two RUs associated with an MU transmission are allocated to the second wireless communication device, as described above, e.g., in connection with reference number 550.

As further shown in FIG. 8, in some aspects, process 800 may include communicating with an access point (AP) based at least in part on using the at least two RUs associated with the MU transmission (block 820). For example, the second wireless communication device (e.g., using communication interface 1335, depicted in FIG. 13, and/or communication manager 140, depicted in FIG. 1) may communicate with an AP based at least in part on using the at least two RUs associated with the MU transmission, as described above, e.g., in connection with reference number 560.

Process 800 may include additional aspects, such as any single aspect or any combination of aspects described below and/or in connection with one or more other processes described elsewhere herein.

In a first aspect, the MU transmission includes at least one of an MU-OFDMA transmission, or an MU-MIMO transmission (e.g., as described in connection with FIG. 5).

In a second aspect, the at least two RUs are associated with an uplink MU transmission, and process 800 includes receiving, in a trigger frame, an indication that the at least two RUs are allocated to the second wireless communication device (e.g., as described in connection with FIG. 5).

In a third aspect, the trigger frame includes a respective user information field for each RU of the at least two RUs allocated to the second wireless communication device, and the indication includes each respective user information field including a device identifier (e.g., a STA identifier) assigned to the second wireless communication device (e.g., as described in connection with FIG. 5). In a fourth aspect, communicating with the first wireless communication device based at least in part on using the at least two RUs includes: transmitting one or more MPDUs (e.g., as described in connection with FIG. 5).

In a fifth aspect, the trigger frame includes at least one user information field that indicates at least one of: a TID limit associated with a basic trigger frame, or a preferred AC associated with the basic trigger frame, and transmitting the one or more MPDUs is based at least in part on the at least one of the TID limit or the preferred AC. (e.g., as described in connection with FIG. 5).

In a sixth aspect, the at least two RUs are associated with a downlink MU transmission, and process 800 includes receiving, in a signal field of the PPDU, an indication that the at least two RUs are allocated to the second wireless communication device (e.g., as described in connection with FIG. 5).

In a seventh aspect, the signal field includes a respective STA information field for each RU of the at least two RUs, and the indication includes each respective STA information field including a device identifier (e.g., a STA identifier) assigned to the second wireless communication device (e.g., as described in connection with FIG. 5).

In an eighth aspect, process 800 includes receiving, based at least in part on the PPDU, respective transmission information for each RU of the at least two RUs allocated to the second wireless communication device (e.g., as described in connection with FIG. 5).

In a ninth aspect, the PPDU includes at least two information fields, each information field of the at least two information fields being addressed to the second wireless communication device and associated with a respective RU of the at least two RUs, each information field of the at least two information fields includes duplicated content, and the duplicated content includes all content of each information field of the at least two information field being duplicated except for RU configuration information (e.g., as described in connection with FIG. 5).

In a tenth aspect, each respective information field of the at least two information fields is at least one of a trigger frame user information field, or a STA information field of a signal field that is included in the PPDU (e.g., as described in connection with FIG. 5).

In an eleventh aspect, the duplicated content in each information field of the at least two information fields is an indication that the MU transmission is expected to carry duplicate transmissions (e.g., as described in connection with FIG. 5).

In a twelfth aspect, communicating with the first wireless communication device based at least in part on using the at least two RUs includes transmitting, using the MU transmission, duplicate PSDUs based at least in part on using the at least two RUs (e.g., as described in connection with FIG. 5).

In a thirteenth aspect, communicating with the first wireless communication device based at least in part on using the at least two RUs includes receiving, as at least part of the MU transmission, duplicate PSDUs based at least in part on using the at least two RUs (e.g., as described in connection with FIG. 5).

In a fourteenth aspect, each RU of the at least two RUs is configured with a respective subchannel associated with the MU transmission (e.g., as described in connection with FIG. 5).

In a fifteenth aspect, communicating with the first wireless communication device based at least in part on using the at least two RUs includes transmitting, as part of the MU transmission, at least one TB PPDU based at least in part on the at least two RUs (e.g., as described in connection with FIG. 5).

In a sixteenth aspect, the at least two RUs include M RUs, the at least one TB PPDU includes N TB PPDUs, M is a first integer, N is a second integer, and N is less than or equal to M (e.g., as described in connection with FIG. 5).

In a seventeenth aspect, each TB PPDU of the at least one TB PPDU is associated with a respective PSDU (e.g., as described in connection with FIG. 5).

In an eighteenth aspect, process 800 includes selecting an RU of the at least two RUs for transmitting a TB PPDU of the at least one TB PPDU based at least in part on at least one of a signal quality associated with the RU, or an availability state associated with the RU (e.g., as described in connection with FIG. 5). In a nineteenth aspect, communicating with the first wireless communication device based at least in part on using the at least two RUs receiving, as at least part of the MU transmission, a MU PPDU based at least in part on the at least two RUs, the MU PPDU includes one or more PSDU, and each PSDU of the one or more PSDU includes at least one of: one or more MPDUs addressed to the second wireless communication device, or a null data packet addressed to the second wireless communication device (e.g., as described in connection with FIG. 5).

In a twentieth aspect, communicating with the first wireless communication device based at least in part on using the at least two RUs associated with the MU transmission includes processing a respective signal, of the MU transmission, for each RU of the at least two RUs based at least in part on respective transmission information associated with the RU (e.g., as described in connection with FIG. 5).

In a twenty-first aspect, processing the respective signal includes at least one of transmitting the respective signal for each RU as part of the MU transmission based at least in part on the respective transmission information, or receiving the respective signal for each RU as part of the MU transmission based at least in part on the respective transmission information (e.g., as described in connection with FIG. 5).

In a twenty-second aspect, the MU transmission includes an uplink TB PPDU (e.g., as described in connection with FIG. 5).

In a twenty-third aspect, the MU transmission includes a downlink MU PPDU (e.g., as described in connection with FIG. 5).

In a twenty-fourth aspect, process 800 includes communicating M-RU capability information associated with the second wireless communication device to the first wireless communication device (e.g., as described in connection with FIG. 5).

In a twenty-fifth aspect, the M-RU capability information indicates device capabilities (e.g., STA capabilities) associated with at least one of duplicating transmission support, a maximum number of decodable PSDUs, or a performance condition (e.g., as described in connection with FIG. 5).

In a twenty-sixth aspect, process 800 includes communicating, to the first wireless communication device, device preferred transmission configuration information (e.g., STA-preferred transmission configuration information) associated with M-RU MU communications, and selecting respective transmission information associated with each RU of the at least two RUs based at least in part on the device-preferred transmission configuration information (e.g., as described in connection with FIG. 5).

In a twenty-seventh aspect, the device-preferred transmission configuration information is based at least in part on an application layer at the second wireless communication device (e.g., as described in connection with FIG. 5).

In a twenty-eighth aspect, process 800 includes receiving an indication that specifies activation of M-RU MU communications (e.g., as described in connection with FIG. 5).

In a twenty-ninth aspect, process 800 includes receiving an indication that specifies deactivation of M-RU MU communications (e.g., as described in connection with FIG. 5).

In a thirtieth aspect, process 800 includes switching to multi-link operations with the first wireless communication device based at least in part on the deactivation of the M-RU MU communications (e.g., as described in connection with FIG. 5).

In a thirty-first aspect, the first wireless communication device is a first AP, and process 800 includes communicating with a second AP based at least in part on using at least one RU of the at least two RUs (e.g., as described in connection with FIG. 5).

In a thirty-second aspect, the first wireless communication device is an AP (e.g., an AP 102), and the second wireless communication device is an STA (e.g., an STA 104) (e.g., as described in connection with FIG. 5).

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

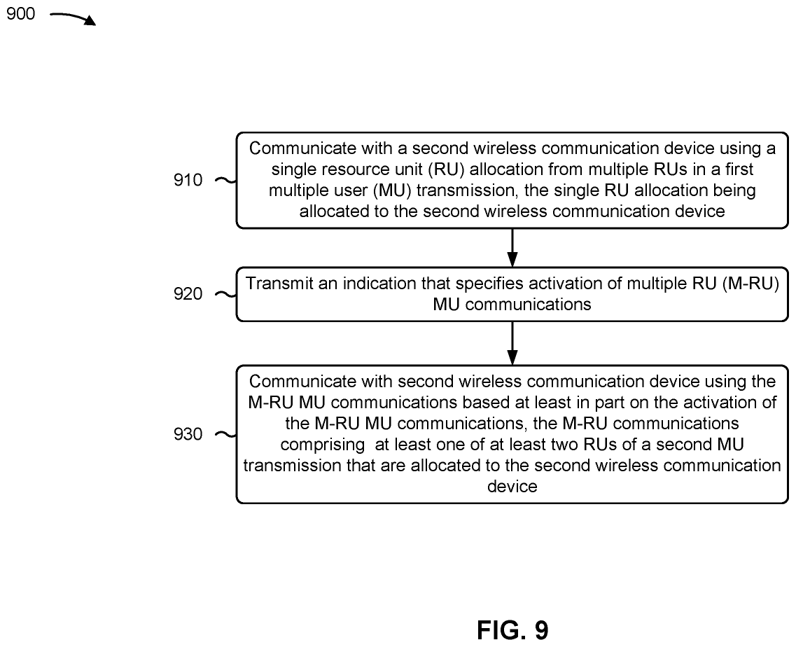

FIG. 9 is a diagram illustrating an example process 900 performed, for example, at a first wireless communication device or an apparatus of a first wireless communication device, in accordance with the present disclosure. Example process 900 is an example where the apparatus or the first wireless communication device (e.g., an AP 102) performs operations associated with allocating multiple RUs of an MU transmission to a single STA.

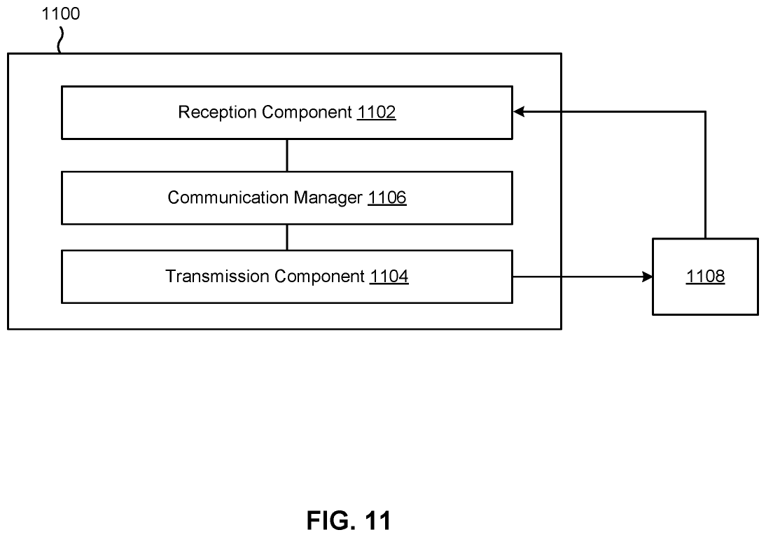

As shown in FIG. 9, in some aspects, process 900 may include communicating with a second wireless communication device using a single RU allocation from multiple RUs in a first MU transmission, the single RU allocation being allocated to the second wireless communication device (block 910). For example, the first wireless communication device (e.g., using reception component 1102, transmission component 1104, and/or communication manager 1106, depicted in FIG. 11) may communicate with a second wireless communication device using a single RU allocation from multiple RUs in a first MU transmission, the single RU allocation being allocated to the second wireless communication device, as described above, e.g., in connection with FIG. 4.

As further shown in FIG. 9, in some aspects, process 900 may include transmitting an indication that specifies activation of M-RU MU communications (block 920). For example, the first wireless communication device (e.g., using transmission component 1106 and/or communication manager 1106, depicted in FIG. 11) may transmit an indication that specifies activation of M-RU MU communications, as described above, e.g., in connection with reference number 510 and reference number 540.

As further shown in FIG. 9, in some aspects, process 900 may include communicating with the second wireless communication device using the M-RU MU communications based at least in part on the activation of the M-RU MU communications, the M-RU communications comprising at least one of at least two RUs of a second MU transmission that are allocated to the second wireless communication device (block 930). For example, the first wireless communication device (e.g., using reception component 1102, transmission component 1104, and/or communication manager 1106, depicted in FIG. 11) may communicate with the second wireless communication device based at least in part on using at least one of at least two RUs of a second MU transmission that are allocated to the second wireless communication device, as described above, e.g., in connection with reference number 550 and reference number 560.

Process 900 may include additional aspects, such as any single aspect or any combination of aspects described below and/or in connection with one or more other processes described elsewhere herein.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

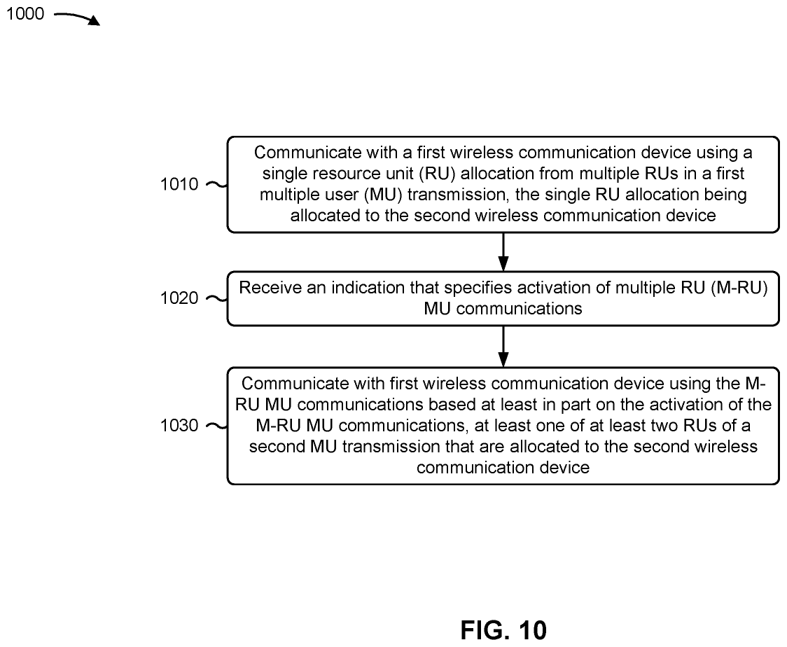

FIG. 10 is a diagram illustrating an example process 1000 performed, for example, at a second wireless communication device or an apparatus of a second wireless communication device, in accordance with the present disclosure. Example process 1000 is an example where the apparatus or the second wireless communication device (e.g., an STA 104) performs operations associated with allocating multiple RUs of an MU transmission to a single STA.

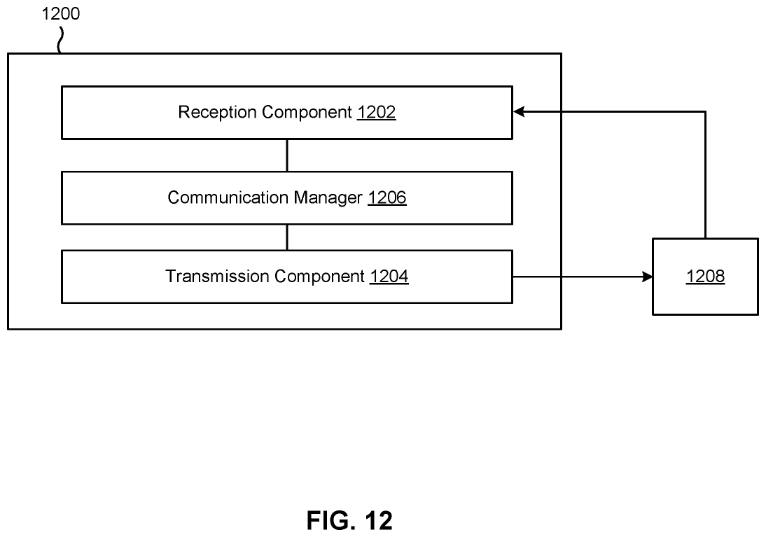

As shown in FIG. 10, in some aspects, process 1000 may include communicating with a first wireless communication device using a single RU allocation from multiple RUs in a first MU transmission, the single RU allocation being allocated to the second wireless communication device (block 1010). For example, the second wireless communication device (e.g., using reception component 1202, transmission component 1204, and/or communication manager 1206, depicted in FIG. 12) may communicate with a first wireless communication device using a single RU allocation from multiple RUs in a first MU transmission, the single RU allocation being allocated to the second wireless communication device, as described above, e.g., in connection with FIG. 4.

As further shown in FIG. 10, in some aspects, process 1000 may include receiving an indication that specifies activation of M-RU MU communications (block 1020). For example, the second wireless communication device (e.g., using reception component 1202 and/or communication manager 1206, depicted in FIG. 12) may receive a first indication that specifies activation of M-RU MU communications, as described above, e.g., in connection with reference number 510 and reference number 540.

As further shown in FIG. 10, in some aspects, process 1000 may include communicating with the first wireless communication device using the M-RU MU communications based at least in part on the activation of the M-RU MU communications, the M-RU communications comprising at least one of at least two RUs of a second MU transmission that are allocated to the second wireless communication device (block 1030). For example, the second wireless communication device (e.g., using reception component 1202, transmission component 1204, and/or communication manager 1206, depicted in FIG. 12) may communicate with the first wireless communication device based at least in part on using at least one of at least two RUs of a second MU transmission that are allocated to the second wireless communication device, as described above, e.g., in connection with reference number 550 and reference number 560.

Process 1000 may include additional aspects, such as any single aspect or any combination of aspects described below and/or in connection with one or more other processes described elsewhere herein.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a first wireless communication device (e.g., an AP), or the first wireless communication device (e.g., an AP) may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a STA or another AP, using the reception component 1102 and the transmission component 1104.

In some aspects, the apparatus 1100 may be configured to perform one or more operations described herein in connection with FIGS. 4-8. Additionally, or alternatively, the apparatus 1100 may be configured to perform one or more processes described herein, such as process 700 of FIG. 7, or a combination thereof. In some aspects, the apparatus 1100 and/or one or more components shown in FIG. 11 may include one or more components of the device 1300 described in connection with FIG. 13. Additionally, or alternatively, one or more components shown in FIG. 11 may be implemented within one or more components described in connection with FIG. 13. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may be a communication interface 1335 as described with regard to FIG. 13. Alternatively, or additionally, the reception component 1102 may include one or more components of device 1300 described in connection with FIG. 13.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may be a communication interface 1335 as described with regard to FIG. 13. Alternatively, or additionally, the transmission component 1104 may include one or more components of the device 1300 described in connection with FIG. 13. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit a PPDU that indicates that at least two RUs associated with an MU transmission are allocated to a second wireless communication device (e.g., a STA 104). The reception component 1102 and/or the transmission component 1104 may communicate with the second wireless communication device based at least in part on using the at least two RUs associated with the MU transmission.

The communication manager 1106 may indicate respective transmission information for each RU of the at least two RUs allocated to the second wireless communication device.

The communication manager 1106 may duplicate, in at least two information fields carried by the PPDU, all content of each information field of the at least two information fields except RU configuration information, each information field of the at least two information fields being addressed to the second wireless communication device and associated with a respective RU of the at least two RUs.

The communication manager 1106 may select an RU of the at least two RUs for transmitting a downlink MU PPDU of the one or more downlink MU PPDUs based at least in part on at least one of a signal quality associated with the RU, or an availability state associated with the RU.

The communication manager 1106 may select a number of RUs associated with the MU transmission to allocate to the second wireless communication device based at least in part on device capability information (e.g., STA capability information).

The communication manager 1106 may communicate with the second wireless communication device to obtain M-RU capability information associated with the second wireless communication device.

The communication manager 1106 may select a number of RUs associated with the MU transmission to allocate to the second wireless communication device based at least in part on the M-RU capability information.

The communication manager 1106 may communicate with the second wireless communication device to obtain STA-preferred transmission configuration information associated with M-RU MU communications.

The communication manager 1106 may select respective transmission information associated with each RU of the at least two RUs based at least in part on the device-preferred transmission configuration information (e.g., STA-preferred transmission configuration information).

The communication manager 1106 may indicate, to the second wireless communication device and by way of the transmission component 1104, activation of M-RU MU communications, and transmitting the PPDU that indicates the at least two RUs are allocated to the second wireless communication device is based at least in part on activation of the M-RU MU communications.

The communication manager 1106 may indicate, to the second wireless communication device and by way of the transmission component 1104, deactivation of the M-RU MU communications.

The communication manager 1106 may enable MLO with the second wireless communication device based at least in part on the deactivation of the M-RU MU communications.

The reception component 1102 and/or the transmission component 1104 may communicate with a second wireless communication device using a single RU allocation from multiple RUs in a first MU transmission, the single RU allocation being allocated to the second wireless communication device. The transmission component 1104 may transmit an indication that specifies activation of M-RU MU communications. The reception component 1102 and/or the transmission component 1104 may communicate (e.g., transmit and/or receive) with the second wireless communication device using the M-RU MU communications based at least in part on the activation of the M-RU MU communications, the M-RU MU communications comprising at least one of at least two RUs of a second MU transmission that are allocated to the second wireless communication device.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a second wireless communication device (e.g., a STA 104), or a second wireless communication device (e.g., a STA 104) may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 4-8. Additionally, or alternatively, the apparatus 1200 may be configured to perform one or more processes described herein, such as process 800 of FIG. 8, or a combination thereof. In some aspects, the apparatus 1200 and/or one or more components shown in FIG. 12 may include one or more components of the device 1300 described in connection with FIG. 13. Additionally, or alternatively, one or more components shown in FIG. 12 may be implemented within one or more components described in connection with FIG. 13. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may be a communication interface 1335 as described in with regard to FIG. 13. Alternatively, or additionally, the reception component 1202 may include one or more components of device 1300 described in connection with FIG. 13.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may be a communication interface 1335 as described with regard to FIG. 13. Alternatively, or additionally, the transmission component 1204 may include one or more components of device 1300 described in connection with FIG. 13. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive a PPDU that indicates at least two RUs associated with an MU transmission are allocated to the second wireless communication device. The reception component 1202 and/or the transmission component 1204 may communicate with a first wireless communication device (e.g., an AP 102) based at least in part on using the at least two RUs associated with the MU transmission.

The reception component 1202 may receive, based at least in part on the PPDU, respective transmission information for each RU of the at least two RUs allocated to the second wireless communication device.

The communication manager 1206 may select an RU of the at least two RUs for transmitting a TB PPDU of the at least one TB PPDU based at least in part on at least one of a signal quality associated with the RU, or an availability state associated with the RU.

The communication manager 1206 may communicate, by way of the transmission component 1204, M-RU capability information associated with the second wireless communication device to the first wireless communication device.

The communication manager 1206 may communicate, to the first wireless communication device and by way of the transmission component 1204, device-preferred transmission configuration information (e.g., STA-preferred transmission configuration information) associated with M-RU MU communications.

The communication manager 1206 may select respective transmission information associated with each RU of the at least two RUs based at least in part on the device-preferred transmission configuration information.

The reception component 1202 may receive an indication that specifies activation of M-RU MU communications.

The reception component 1202 may receive an indication that specifies deactivation of M-RU MU communications.

The communication manager 1206 may switch to multi-link operations with the AP based at least in part on the deactivation of the M-RU MU communications.

The reception component 1202 and/or the transmission component 1204 may communicate with a first wireless communication device using a single RU allocation from multiple RUs in a first MU transmission, the single RU allocation being allocated to the second wireless communication device. The reception component 1202 may receive a first indication that specifies activation of M-RU MU communications. The reception component 1202 and/or the transmission component 1204 may communicate with the first wireless communication device using the M-RU MU communications based at least in part on the activation of the M-RU MU communications, the M-RU MU communications comprising at least one of at least two RUs of a second MU transmission that are allocated to the second wireless communication device.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram illustrating example components of a device 1300, in accordance with the present disclosure. Device 1300 may correspond to a first wireless communication device (e.g., an AP 102 and/or an STA 104) and/or a second wireless communication device (e.g., a STA 104). In some aspects, the first wireless communication device and/or the second wireless communication device may include one or more devices 1300 and/or one or more components of device 1300. As shown in FIG. 13, device 1300 may include a bus 1305, a processor 1310, a memory 1315, a storage component 1320, an input component 1325, an output component 1330, and/or a communication interface 1335.

Bus 1305 includes a component that permits communication among the components of device 1300. Processor 1310 is implemented in hardware, firmware, or a combination of hardware and software. Processor 1310 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 1310 includes one or more processors capable of being programmed to perform a function. Memory 1315 includes a random access memory (RAM), a read only memory (ROM), and/or another type of dynamic or static storage device (e.g., a flash memory, a magnetic memory, and/or an optical memory) that stores information and/or instructions for use by processor 1310.

Storage component 1320 stores information and/or software related to the operation and use of device 1300. For example, storage component 1320 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 1325 includes a component that permits device 1300 to receive information, such as via user input (e.g., a touch screen display, a keyboard, a keypad, a mouse, a button, a switch, and/or a microphone). Additionally, or alternatively, input component 1325 may include a component for determining a position or a location of device 1300 (e.g., a global positioning system (GPS) component or a global navigation satellite system (GNSS) component) and/or a sensor for sensing information (e.g., an accelerometer, a gyroscope, an actuator, or another type of position or environment sensor). Output component 1330 includes a component that provides output information from device 1300 (e.g., a display, a speaker, a haptic feedback component, and/or an audio or visual indicator).

Communication interface 1335 includes a transceiver-like component (e.g., a transceiver and/or a separate receiver and transmitter) that enables device 1300 to communicate with other devices, such as via a wired connection, a wireless connection, or a combination of wired and wireless connections. Communication interface 1335 may permit device 1300 to receive information from another device and/or provide information to another device. For example, communication interface 1335 may include an Ethernet interface, an optical interface, a coaxial interface, an infrared interface, a radio frequency interface, a universal serial bus (USB) interface, a wireless local area interface (e.g., a Wi-Fi interface), and/or a cellular network interface.

Device 1300 may perform one or more processes described herein. Device 1300 may perform these processes based on processor 1310 executing software instructions stored by a non-transitory computer-readable medium, such as memory 1315 and/or storage component 1320. A computer-readable medium is defined herein as a non-transitory memory device. A memory device includes memory space within a single physical storage device or memory space spread across multiple physical storage devices.

Software instructions may be read into memory 1315 and/or storage component 1320 from another computer-readable medium or from another device via communication interface 1335. When executed, software instructions stored in memory 1315 and/or storage component 1320 may cause processor 1310 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

In some aspects, the device 1300 may include means for transmitting a PPDU that indicates that at least two RUs associated with an MU transmission are allocated to a second wireless communication device (e.g., a STA); and/or means for communicating with the second wireless communication device based at least in part on using the at least two RUs associated with the MU transmission. In some aspects, the means for the device 1300 to perform operations described herein may include, for example, one or more of communication manager 150, bus 1305, processor 1310, memory 1315, storage component 1320, input component 1325, output component 1330, and/or communication interface 1335.

In some aspects, the device 1300 may include means for receiving a PPDU that indicates at least two RUs associated with an MU transmission are allocated to the device 1300; and/or means for communicating with a first wireless communication device (e.g., an AP) based at least in part on using the at least two RUs associated with the MU transmission. In some aspects, the means for the device 1300 to perform operations described herein may include, for example, one or more of communication manager 140, bus 1305, processor 1310, memory 1315, storage component 1320, input component 1325, output component 1330, and/or communication interface 1335.

In some aspects, the device 1300 includes means for communicating with a wireless communication device using a single RU allocation from multiple RUs in a first MU transmission, the single RU allocation being allocated to the second wireless communication device; means for transmitting an indication that specifies activation of M-RU MU communications; and/or means for communicating with the second wireless communication device based at least in part on using at least one of at least two RUs of a second MU transmission that are allocated to the second wireless communication device. In some aspects, the means for the device 1300 to perform operations described herein may include, for example, one or more of communication manager 140, bus 1305, processor 1310, memory 1315, storage component 1320, input component 1325, output component 1330, and/or communication interface 1335.

In some aspects, the device 1300 includes means for communicating with a wireless communication device using a single RU allocation from multiple RUs in a first MU transmission, the single RU allocation being allocated to a second wireless communication device; means for receiving a first indication that specifies activation of M-RU MU communications; and/or means for communicating with the first wireless communication device based at least in part on using at least one of at least two RUs of a second MU transmission that are allocated to the second wireless communication device. In some aspects, the means for the device 1300 to perform operations described herein may include, for example, one or more of communication manager 140, bus 1305, processor 1310, memory 1315, storage component 1320, input component 1325, output component 1330, and/or communication interface 1335.

The number and arrangement of components shown in FIG. 13 are provided as an example. In practice, device 1300 may include additional components, fewer components, different components, or differently arranged components than those shown in FIG. 13. Additionally, or alternatively, a set of components (e.g., one or more components) of device 1300 may perform one or more functions described as being performed by another set of components of device 1300.

The following provides an overview of some Aspects of the present disclosure:

Aspect 1: A method of wireless communication performed by a first wireless communication device, comprising: transmitting a physical layer protocol data unit (PPDU) that indicates that at least two resource units (RUs) associated with a multiple-user (MU) transmission are allocated to a second wireless communication device; and communicating with the second wireless communication device based at least in part on using the at least two resource units (RUs) associated with the MU transmission.

Aspect 2: The method of Aspect 1, wherein the MU transmission includes at least one of: an MU orthogonal frequency division multiple access (OFDMA) transmission, or an MU multiple-input-multiple-output (MIMO) transmission.

Aspect 3: The method of any of Aspects 1-2, wherein the at least two RUs are associated with an uplink MU transmission, and the method includes: transmitting, in a trigger frame, an indication that the at least two RUs are allocated to the second wireless communication device.

Aspect 4: The method of Aspect 3, wherein the trigger frame includes a respective user information field for each RU of the at least two RUs allocated to the second wireless communication device, and wherein the indication includes each respective user information field including a device identifier assigned to the second wireless communication device.

Aspect 5: The method of Aspect 3, wherein communicating with the STA based at least in part on using the at least two RUs includes: receiving one or more medium access control protocol data units (MPDUs).

Aspect 6: The method of Aspect 5, wherein the trigger frame includes at least one user information field that indicates at least one of: a traffic identifier (TID) limit associated with a basic trigger frame, or a preferred access class (AC) associated with the basic trigger frame, and wherein receiving the one or more MPDUs is based at least in part on the at least one of the TID limit or the preferred AC.

Aspect 7: The method of any of Aspects 1-6, wherein the at least two RUs are associated with a downlink MU transmission, and the method includes: transmitting, in a signal field of the PPDU, an indication that the at least two RUs are allocated to the second wireless communication device.

Aspect 8: The method of Aspect 7, wherein the signal field includes a respective wireless station (STA) information field for each RU of the at least two RUs, and wherein the indication includes each respective STA information field including a device identifier assigned to the second wireless communication device.

Aspect 9: The method of any of Aspects 1-8, further including: indicating respective transmission information for each RU of the at least two RUs allocated to the second wireless communication device.

Aspect 10: The method of any of Aspects 1-9, further including: duplicating, in at least two information fields carried by the PPDU, all content of each information field of the at least two information fields except RU configuration information, each information field of the at least two information fields being addressed to the second wireless communication device and associated with a respective RU of the at least two RUs.

Aspect 11: The method of Aspect 10, wherein each respective information field of the at least two information fields, is at least one of: a trigger frame user information field, or a wireless station (STA) information field of a signal field that is included in the PPDU.

Aspect 12: The method of Aspect 10, wherein duplicated content in the at least two information fields is an indication that the MU transmission is expected to carry duplicate transmissions.

Aspect 13: The method of Aspect 10, wherein communicating with the second wireless communication device based at least in part on using the at least two RUs includes: receiving, using the MU transmission, duplicate physical layer service data units (PSDUs) based at least in part on using the at least two RUs.

Aspect 14: The method of Aspect 10, wherein communicating with the second wireless communication device based at least in part on using the at least two RUs includes: transmitting, as at least part of the MU transmission, duplicate physical layer service data units (PSDUs) based at least in part on using the at least two RUs.

Aspect 15: The method of any of Aspects 1-14, wherein each RU of the at least two RUs is configured with a respective subchannel associated with the MU transmission.

Aspect 16: The method of any of Aspects 1-15, wherein communicating with the second wireless communication device based at least in part on using the at least two RUs includes: receiving, using the MU transmission, at least one trigger-based (TB) PPDU based at least in part on the at least two RUs.

Aspect 17: The method of Aspect 16, wherein the at least two RUs include M RUs, wherein the at least one TB PPDU includes NTB PPDUs, wherein M is a first integer and N is a second integer, and wherein Nis less than or equal to M.

Aspect 18: The method of Aspect 17, wherein each TB PPDU of the at least one TB PPDU is associated with a respective physical layer service data unit (PSDU).

Aspect 19: The method of any of Aspects 1-18, wherein communicating with the STA based at least in part on using the at least two RUs includes: transmitting, using the MU transmission, an MU PPDU based at least in part on the at least two RUs, wherein the MU PPDU includes one or more physical layer service data units (PSDU), and wherein each PSDU of the one or more PSDU includes at least one of: one or more medium access control protocol data units (MPDUs) addressed to the STA, or a null data packet addressed to the STA.

Aspect 20: The method of Aspect 19, further including: selecting an RU of the at least two RUs for transmitting the MU PPDU based at least in part on at least one of: a signal quality associated with the RU, or an availability state associated with the RU.

Aspect 21: The method of Aspect 19, further including: selecting a number of RUs associated with the MU transmission to allocate to the second wireless communication device based at least in part on device capability information.

Aspect 22: The method of any of Aspects 1-21, wherein communicating with the second wireless communication device based at least in part on using the at least two RUs associated with the MU transmission includes: processing a respective signal, of the MU transmission, for each RU of the at least two RUs based at least in part on respective transmission information associated with the RU.

Aspect 23: The method of Aspect 22, wherein processing the respective signal that is associated with each RU includes at least one of: transmitting the respective signal for each RU as part of the MU transmission based at least in part on the respective transmission information; or receiving the respective signal for each RU as at least part of the MU transmission based at least in part on the respective transmission information.

Aspect 24: The method of Aspect 22, wherein the MU transmission includes an uplink trigger-based (TB) PPDU.

Aspect 25: The method of Aspect 22, wherein the MU transmission includes a downlink MU PPDU.

Aspect 26: The method of any of Aspects 1-25, further including: communicating with the second wireless communication device to obtain multiple-RU (M-RU) capability information associated with the second wireless communication device; and selecting a number of RUs associated with the MU transmission to allocate to the second wireless communication device based at least in part on the M-RU capability information.

Aspect 27: The method of Aspect 26, wherein the M-RU capability information indicates device capabilities associated with at least one of: duplicate transmission support, a maximum number of decodable physical layer service data units (PSDUs), or a performance condition.

Aspect 28: The method of any of Aspects 1-27, further including: communicating with the second wireless communication device to obtain device-preferred transmission configuration information associated with multiple-RU (M-RU) MU communications; and selecting respective transmission information associated with each RU of the at least two RUs based at least in part on the device-preferred transmission configuration information.

Aspect 29: The method of Aspect 28, wherein the device-preferred transmission configuration information is based at least in part on an application layer at the second wireless communication device.

Aspect 30: The method of any of Aspects 1-29, further including: indicating, to the second wireless communication device, activation of multiple RU (M-RU) MU communications, wherein transmitting the PPDU that indicates the at least two RUs are allocated to the second wireless communication device is based at least in part on activation of the M-RU MU communications.

Aspect 31: The method of Aspect 30, further including: changing, based at least in part on the activation, at least one of: a number of RUs allocated to the second wireless communication device, or one or more transmission parameters associated with the MU communication.

Aspect 32: The method of any of Aspects 1-31, further including: indicating, to the second wireless communication device, deactivation of the M-RU MU communications.

Aspect 33: The method of Aspect 32, further including: enabling multi-link operations with the second wireless communication device based at least in part on the deactivation of the M-RU MU communications.

Aspect 34: The method of Aspect 32, further including: changing, based at least in part on the deactivation, at least one of: a number of RUs allocated to the second wireless communication device, or one or more transmission parameters associated with the MU communication.

Aspect 35: The method of any of Aspects 1-34, wherein the first wireless communication device is a first access point (AP), wherein the second wireless communication device is a wireless station (STA), and the method further includes: communicating with a second AP that is in communication with the STA; selecting at least one RU of the at least two RUs for second wireless communication device communications with the second AP; and indicating a configuration of the at least one RU to the second AP.

Aspect 36: A method of wireless communication performed by a second wireless communication device, comprising: receiving a single physical layer protocol data unit (PPDU) that indicates at least two resource units (RUs) associated with a multiple-user (MU) transmission are allocated to the second wireless communication device; and communicating with a first wireless communication device based at least in part on using the at least two RUs associated with the MU transmission.

Aspect 37: The method of Aspect 36, wherein the MU transmission includes at least one of: an MU orthogonal frequency division multiple access (OFDMA) transmission, or an MU multiple-input-multiple-output (MIMO) transmission.

Aspect 38: The method of any of Aspects 36-37, wherein the at least two RUs are associated with an uplink MU transmission, and the method includes: receiving, in a trigger frame, an indication that the at least two RUs are allocated to the second wireless communication device.

Aspect 39: The method of Aspect 38, wherein the trigger frame includes a respective user information field for each RU of the at least two RUs allocated to the second wireless communication device, and wherein the indication includes each respective user information field including a device identifier assigned to the second wireless communication device.

Aspect 40: The method of Aspect 38, wherein communicating with the first wireless communication device based at least in part on using the at least two RUs includes: transmitting one or more medium access control protocol data units (MPDUs).

Aspect 41: The method of Aspect 40, wherein the trigger frame includes at least one user information field that indicates at least one of: a traffic identifier (TID) limit associated with a basic trigger frame, or a preferred access class (AC) associated with the basic trigger frame, and wherein transmitting the one or more MPDUs is based at least in part on the at least one of the TID limit or the preferred AC.

Aspect 42: The method of any of Aspects 36-41, wherein the at least two RUs are associated with a downlink MU transmission, and the method includes: receiving, in a signal field of the PPDU, an indication that the at least two RUs are allocated to the second wireless communication device.

Aspect 43: The method of Aspect 42, wherein the signal field includes a respective wireless station (STA) information field for each RU of the at least two RUs, and wherein the indication includes each respective STA information field including a device identifier assigned to the second wireless communication device.

Aspect 44: The method of any of Aspects 36-43, further including: receiving, based at least in part on the PPDU, respective transmission information for each RU of the at least two RUs allocated to the second wireless communication device.

Aspect 45: The method of any of Aspects 36-44, wherein the PPDU includes at least two information fields, each information field of the at least two information fields being addressed to the second wireless communication device and associated with a respective RU of the at least two RUs, wherein each information field of the at least two information fields includes duplicated content, and wherein the duplicated content includes all content of each information field of the at least two information fields being duplicated except for RU configuration information.

Aspect 46: The method of Aspect 45, wherein each respective information field of the at least two information fields is at least one of: a trigger frame user information field, or a wireless station (STA) information field of a signal field that is included in the PPDU.

Aspect 47: The method of Aspect 45, wherein the duplicated content in each information field of the at least two information fields is an indication that the MU transmission is expected to carry duplicate transmissions.

Aspect 48: The method of Aspect 45, wherein communicating with the first wireless communication device based at least in part on using the at least two RUs includes: transmitting, using the MU transmission, duplicate physical layer service data units (PSDUs) based at least in part on using the at least two RUs.

Aspect 49: The method of Aspect 45, wherein communicating with the first wireless communication device based at least in part on using the at least two RUs includes: receiving, as at least part of the MU transmission, duplicate physical layer service data units (PSDUs) based at least in part on using the at least two RUs.

Aspect 50: The method of any of Aspects 36-49, wherein each RU of the at least two RUs is configured with a respective subchannel associated with the MU transmission.

Aspect 51: The method of any of Aspects 36-50, wherein communicating with the first wireless communication device based at least in part on using the at least two RUs includes: transmitting, as part of the MU transmission, at least one trigger-based (TB) PPDU based at least in part on the at least two RUs.

Aspect 52: The method of Aspect 51, wherein the at least two RUs include M RUs, wherein the at least one TB PPDU includes NTB PPDUs, wherein M is a first integer and N is a second integer, and wherein N less than or equal to M.

Aspect 53: The method of Aspect 51, wherein each TB PPDU of the at least one TB PPDU is associated with a respective physical layer service data unit (PSDU).

Aspect 54: The method of Aspect 51, further including: selecting an RU of the at least two RUs for transmitting a TB PPDU of the at least one TB PPDU based at least in part on at least one of: a signal quality associated with the RU, or an availability state associated with the RU.

Aspect 55: The method of Aspect 34, wherein communicating with the first wireless communication device based at least in part on using the at least two RUs includes: receiving, as at least part of the MU transmission, a MU PPDU based at least in part on the at least two RUs, wherein the MU PPDU includes one or more physical layer service data units (PSDU), and wherein each PSDU of the one or more PSDU includes at least one of: one or more medium access control protocol data units (MPDUs) addressed to the second wireless communication device, or a null data packet addressed to the second wireless communication device.

Aspect 56: The method of any of Aspects 36-55, wherein communicating with the first wireless communication device based at least in part on using the at least two RUs associated with the MU transmission includes: processing a respective signal, of the MU transmission, for each RU of the at least two RUs based at least in part on respective transmission information associated with the RU.

Aspect 57: The method of Aspect 56, wherein processing the respective signal includes at least one of: transmitting the respective signal for each RU as part of the MU transmission based at least in part on the respective transmission information; or receiving the respective signal for each RU as part of the MU transmission based at least in part on the respective transmission information.

Aspect 58: The method of Aspect 56, wherein the MU transmission includes an uplink trigger-based (TB) PPDU.

Aspect 59: The method of Aspect 54, wherein the MU transmission includes a downlink MU PPDU.

Aspect 60: The method of any of Aspects 36-59, further including: communicating multiple-RU (M-RU) capability information associated with the second wireless communication device to the first wireless communication device.

Aspect 61: The method of Aspect 60, wherein the M-RU capability information indicates device capabilities associated with at least one of: duplicate transmission support, a maximum number of decodable physical layer service data units (PSDUs), or a performance condition.

Aspect 62: The method of any of Aspects 36-61, further including: communicating, to the first wireless communication device, device-preferred transmission configuration information associated with multiple-RU (M-RU) MU communications; and selecting respective transmission information associated with each RU of the at least two RUs based at least in part on the device-preferred transmission configuration information.

Aspect 63: The method of Aspect 65, wherein the device-preferred transmission configuration information is based at least in part on an application layer at the second wireless communication device.

Aspect 64: The method of any of Aspects 36-63, further including: receiving an indication that specifies activation of multiple RU (M-RU) MU communications.

Aspect 65: The method of any of Aspects 36-64, further including: receiving an indication that specifies deactivation of multiple RU (M-RU) MU communications.

Aspect 66: The method of Aspect 65, further including: switching to multi-link operations with the first wireless communication device based at least in part on the deactivation of the M-RU MU communications.

Aspect 67: The method of any of Aspects 36-66, wherein the first wireless communication device is a first access point (AP), and the method further includes: communicating with a second AP based at least in part on using at least one RU of the at least two RUs.

Aspect 68: An apparatus for wireless communication at a device, comprising a processor; memory coupled with the processor; and instructions stored in the memory and executable by the processor to cause the apparatus to perform the method of one or more of Aspects 1-67.

Aspect 69: A device for wireless communication, comprising a memory and one or more processors coupled to the memory, the one or more processors configured, individually or collectively, to perform the method of one or more of Aspects 1-67.

Aspect 70: An apparatus for wireless communication, comprising at least one means for performing the method of one or more of Aspects 1-67.

Aspect 71: A non-transitory computer-readable medium storing code for wireless communication, the code comprising instructions executable by a processor to perform the method of one or more of Aspects 1-67.

Aspect 72: A non-transitory computer-readable medium storing a set of instructions for wireless communication, the set of instructions comprising one or more instructions that, when executed by one or more processors of a device, cause the device to perform the method of one or more of Aspects 1-67.

Aspect 73: A method of wireless communication performed by a first wireless communication device, comprising: communicating with a second wireless communication device using a single resource unit (RU) allocation from multiple RUs in a first multiple user (MU) transmission, the single RU allocation being allocated to the second wireless communication device; transmitting an indication that specifies activation of multiple RU (M-RU) MU communications; and communicating with the second wireless communication device using the M-RU MU communications based at least in part on the activation of the M-RU MU communications, the M-RU communications comprising at least one of at least two RUs of a second MU transmission that are allocated to the second wireless communication device.

Aspect 74: A method of wireless communication performed by a second wireless communication device, comprising: communicating with a first wireless communication device using a single resource unit (RU) allocation from multiple RUs in a first multiple user (MU) transmission, the single RU allocation being allocated to the second wireless communication device; receiving a first indication that specifies activation of multiple RU (M-RU) MU communications; and communicating with the first wireless communication device using the M-RU MU communications based at least in part on the activation of the M-RU MU communications, the M-RU communications comprising at least one of at least two RUs of a second MU transmission that are allocated to the second wireless communication device.

Aspect 75: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 73.

Aspect 76: An apparatus for wireless communication at a device, the apparatus comprising one or more memories and one or more processors coupled to the one or more memories, the one or more processors configured to cause the device to perform the method of one or more of Aspects 73.

Aspect 77: An apparatus for wireless communication, the apparatus comprising at least one means for performing the method of one or more of Aspects 73.

Aspect 78: A non-transitory computer-readable medium storing code for wireless communication, the code comprising instructions executable by one or more processors to perform the method of one or more of Aspects 73.

Aspect 79: A non-transitory computer-readable medium storing a set of instructions for wireless communication, the set of instructions comprising one or more instructions that, when executed by one or more processors of a device, cause the device to perform the method of one or more of Aspects 73.

Aspect 80: A device for wireless communication, the device comprising a processing system that includes one or more processors and one or more memories coupled with the one or more processors, the processing system configured to cause the device to perform the method of one or more of Aspects 73.

Aspect 81: An apparatus for wireless communication at a device, the apparatus comprising one or more memories and one or more processors coupled to the one or more memories, the one or more processors individually or collectively configured to cause the device to perform the method of one or more of Aspects 73.

Aspect 82: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 74.

Aspect 83: An apparatus for wireless communication at a device, the apparatus comprising one or more memories and one or more processors coupled to the one or more memories, the one or more processors configured to cause the device to perform the method of one or more of Aspects 74.

Aspect 84: An apparatus for wireless communication, the apparatus comprising at least one means for performing the method of one or more of Aspects 74.

Aspect 85: A non-transitory computer-readable medium storing code for wireless communication, the code comprising instructions executable by one or more processors to perform the method of one or more of Aspects 74.

Aspect 86: A non-transitory computer-readable medium storing a set of instructions for wireless communication, the set of instructions comprising one or more instructions that, when executed by one or more processors of a device, cause the device to perform the method of one or more of Aspects 74.

Aspect 87: A device for wireless communication, the device comprising a processing system that includes one or more processors and one or more memories coupled with the one or more processors, the processing system configured to cause the device to perform the method of one or more of Aspects 74.

Aspect 88: An apparatus for wireless communication at a device, the apparatus comprising one or more memories and one or more processors coupled to the one or more memories, the one or more processors individually or collectively configured to cause the device to perform the method of one or more of Aspects 74.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. An apparatus for wireless communication at a first wireless communication device, comprising:
one or more memories; and
one or more processors, coupled to the one or more memories, configured, individually or collectively, to cause the first wireless communication device to:
communicate with a second wireless communication device using a single resource unit (RU) allocation from multiple RUs in a first multiple user (MU)
transmission, the single RU allocation being allocated to the second wireless communication device;
transmit an indication that specifies activation of multiple RU (M-RU) MU communications; and
communicate with the second wireless communication device using the M-RU MU communications based at least in part on the activation of the M-RU MU communications, the M-RU communications comprising at least one of at least two RUs of a second MU transmission that are allocated to the second wireless communication device.

2. The apparatus of claim 1, wherein the one or more processors are further configured to cause the first wireless communication device to:
change, based at least in part on the activation, at least one of:
a number of RUs allocated to the second wireless communication device, or
one or more transmission parameters associated with the M-RU MU communications.

3. The apparatus of claim 1, wherein the one or more processors are further configured to cause the first wireless communication device to:
indicate, to the second wireless communication device, deactivation of the M-RU MU communications.

4. The apparatus of claim 3, wherein the one or more processors are further configured to cause the first wireless communication device to:
enable multi-link operations with the second wireless communication device based at least in part on the deactivation of the M-RU MU communications.

5. The apparatus of claim 1, wherein the one or more processors are further configured to cause the first wireless communication device to:
transmit a physical layer protocol data unit (PPDU) that indicates that the at least two RUs associated with the second MU transmission are allocated to the second wireless communication device.

6. The apparatus of claim 1, wherein the one or more processors are further configured to cause the first wireless communication device to:
obtain M-RU capability information associated with the second wireless communication device,
wherein transmitting the indication that specifies activation of the M-RU MU communications is based at least in part on the M-RU capability information.

7. The apparatus of claim 6, wherein the M-RU capability information indicates the second wireless communication device supports the M-RU MU communications.

8. The apparatus of claim 6, wherein the one or more processors are further configured to cause the first wireless communication device to:
select a number of RUs associated with the second MU transmission to allocate to the second wireless communication device based at least in part on the M-RU capability information.

9. The apparatus of claim 6, wherein the M-RU capability information indicates device capabilities associated with at least one of:
duplicate transmission support,
a maximum number of decodable physical layer service data units (PSDUs), or
a performance condition.

10. An apparatus for wireless communication at a second wireless communication device, comprising:
one or more memories; and
one or more processors, coupled to the one or more memories, configured to cause the second wireless communication device to:
communicate with a first wireless communication device using a single resource unit (RU) allocation from multiple RUs included in a first multiple user (MU) transmission, the single RU allocation being allocated to the second wireless communication device;
receive a first indication that specifies activation of multiple RU (M-RU) MU communications; and
communicate with the first wireless communication device using the M-RU MU communications based at least in part on the activation of the M-RU MU communications, the M-RU communications comprising at least one of at least two RUs of a second MU transmission that are allocated to the second wireless communication device.

11. The apparatus of claim 10, wherein the one or more processors are further configured to cause the second wireless communication device to:
receive a second indication that specifies deactivation of the M-RU MU communications.

12. The apparatus of claim 11, wherein the one or more processors are further configured to cause the second wireless communication device to:
enable multi-link operations with the first wireless communication device based at least in part on the deactivation of the M-RU MU communications.

13. The apparatus of claim 10, wherein the one or more processors are further configured to cause the second wireless communication device to:
receive a physical layer protocol data unit (PPDU) that indicates that the at least two RUs associated with the second MU transmission are allocated to the second wireless communication device.

14. The apparatus of claim 10, wherein the one or more processors are further configured to cause the second wireless communication device to:
transmit M-RU capability information that indicates support for the M-RU MU communications.

15. The apparatus of claim 14, wherein the M-RU capability information indicates device capabilities associated with at least one of:
duplicate transmission support,
a maximum number of decodable physical layer service data units (PSDUs), or
a performance condition.

16. A method of wireless communication performed by a first wireless communication device, comprising:
communicating with a second wireless communication device using a single resource unit (RU) allocation from multiple RUs in a first multiple user (MU) transmission, the single RU allocation being allocated to the second wireless communication device;
transmitting an indication that specifies activation of multiple RU (M-RU) MU communications; and
communicating with the second wireless communication device using the M-RU MU communications based at least in part on the activation of the M-RU MU communications, the M-RU communications comprising at least one of at least two RUs of a second MU transmission that are allocated to the second wireless communication device.

17. The method of claim 16, further comprising:
changing, based at least in part on the activation, at least one of:
a number of RUs allocated to the second wireless communication device, or
one or more transmission parameters associated with the M-RU MU communications.

18. The method of claim 16, further comprising:
indicating, to the second wireless communication device, deactivation of the M-RU MU communications.

19. The method of claim 18, further comprising:
enabling multi-link operations with the second wireless communication device based at least in part on the deactivation of the M-RU MU communications.

20. The method of claim 16, further comprising:
transmitting a physical layer protocol data unit (PPDU) that indicates that the at least two RUs associated with the second MU transmission are allocated to the second wireless communication device.

21. The method of claim 16, further comprising:
obtaining M-RU capability information associated with the second wireless communication device,
wherein transmitting the indication that specifies activation of the M-RU MU communications is based at least in part on the M-RU capability information.

22. The method of claim 21, wherein the M-RU capability information indicates the second wireless communication device supports the M-RU MU communications.

23. The method of claim 22, further comprising:
selecting a number of RUs associated with the second MU transmission to allocate to the second wireless communication device based at least in part on the M-RU capability information.

24. The method of claim 22, wherein the M-RU capability information indicates device capabilities associated with at least one of:
duplicate transmission support,
a maximum number of decodable physical layer service data units (PSDUs), or
a performance condition.

25. A method for wireless communication at a second wireless communication device, comprising:
communicating with a first wireless communication device using a single resource unit (RU) allocation from multiple RUs included in a first multiple user (MU) transmission, the single RU allocation being allocated to the second wireless communication device;
receiving a first indication that specifies activation of multiple RU (M-RU) MU communications; and
communicating with the first wireless communication device using the M-RU MU communications based at least in part on the activation of the M-RU MU communications, the M-RU communications comprising at least one of at least two RUs of a second MU transmission that are allocated to the second wireless communication device.

26. The method of claim 25, further comprising:
receive a second indication that specifies deactivation of the M-RU MU communications.

27. The method of claim 26, further comprising:
enabling multi-link operations with the first wireless communication device based at least in part on the deactivation of the M-RU MU communications.

28. The method of claim 25, further comprising:
receiving a physical layer protocol data unit (PPDU) that indicates that the at least two RUs associated with the second MU transmission are allocated to the second wireless communication device.

29. The method of claim 25, further comprising:
transmitting M-RU capability information that indicates support for the M-RU MU communications.

30. The method of claim 29, wherein the M-RU capability information indicates device capabilities associated with at least one of:
duplicate transmission support,
a maximum number of decodable physical layer service data units (PSDUs), or
a performance condition.
